(19) United States
(12) Patent Application Publication
(10) Pub. No.: US 2025/0353025 A1
(43) Pub. Date: Nov. 20, 2025

(54) PUMP DRIVE SYSTEM

(71) Applicant: Graco Minnesota Inc., Minneapolis, MN (US)

(72) Inventors: Todd B. Hillukka, Clearwater, MN (US); Jacob D. Scherer, Clear Lake, MN (US); Bryan K. Colby, New Brighton, MN (US)

(21) Appl. No.: 18/867,699

(22) PCT Filed: May 25, 2023
(86) PCT No.: PCT/US2023/023553

§ 371 Date: Nov. 20, 2024

Related U.S. Application Data
(60) Provisional application No. 63/346,224, filed on May 26, 2022.
(60) Provisional application No. 63/452,274, filed on Mar. 15, 2023.

(51) Int. Cl. B05B 9/04; B05B 12/08; F04B 17/03

(52) U.S. Cl. CPC B05B 9/0413; B05B 12/085; F04B 17/03

(57) ABSTRACT

A pump drive system (10) is configured to drive operation of a pump (19) to pump spray fluid to a spray gun (5) for spraying. The drive system includes an electric motor (12) configured to provide a rotational output for powering the pump and includes a controller (15) configured to control operation of the electric motor. The controller controls operation of the electric motor based on a target pressure for the fluid output by the pump and/or based on a position of the fluid displacer (16) of the pump.

### CROSS-REFERENCE TO RELATED APPLICATION(S)

This application claims priority to U.S. Provisional Application No. 63/346,224 filed May 26, 2022 and entitled “PUMP DRIVE SYSTEM,” and this application claims priority to U.S. Provisional Application No. 63/452,274 filed Mar. 15, 2023 and entitled “PUMP DRIVE SYSTEM,” the disclosures of which are hereby incorporated by reference in their entireties.

### BACKGROUND

The present disclosure relates generally to fluid displacement systems and, more particularly, to drive systems for reciprocating fluid displacement pumps.

Fluid displacement systems, such as fluid dispensing systems for paint, typically utilize positive displacement pumps such as axial displacement pumps to pull a fluid from a container and to drive the fluid downstream. The axial displacement pump is typically mounted to a drive housing and driven by a motor. A pump rod is attached to a reciprocating drive that drives reciprocation of the pump rod, thereby pulling fluid from a container into the pump and then driving the fluid downstream from the pump. In some cases, electric motors can power the pump. The electric motor is attached to the pump via a gear reduction system that increases the torque of the motor.

### SUMMARY

According to an aspect of the disclosure, a fluid sprayer includes an electric motor that outputs rotational motion; a drive that converts the rotational motion output from the electric motor into linear reciprocating motion; a pump driven by the drive; a hose that receives an output of a fluid from the pump; a spray gun that receives the fluid from the hose; at least one sensor; and a controller configured to receive an output from the at least one sensor and control operation of the electric motor based on the output from the at least one sensor.

According to an additional or alternative aspect of the disclosure, a fluid sprayer includes an electric motor that outputs rotational motion; a drive that converts the rotational motion output from the electric motor into linear reciprocating motion; a pump driven by the drive; a hose that receives an output of a fluid from the pump; a spray gun that receives the fluid from the hose; at least one sensor configured to generate information regarding a pressure output by the pump; and a controller. The controller configured to receive an output from the at least one sensor and control operation of the electric motor based on the information from the at least one sensor; operate in a first mode based on a target output pressure from the pump being in a first pressure range, the controller controlling starting and stopping of the electric motor based on the pressure monitored by the sensor passing out of a first threshold range when operating in the first mode; and operate in a second mode based on the target output pressure from the pump being in a second pressure range, the controller controlling starting and stopping of the electric motor based on the pressure monitored by the sensor passing out of a second threshold range when operating in the second mode. A first pressure differential of the first threshold range differs from a second pressure differential of the second threshold range.

According to another additional or alternative aspect of the disclosure, a fluid sprayer includes an electric motor that outputs rotational motion; a drive that converts the rotational motion output from the electric motor into linear reciprocating motion; a pump driven by the drive; a hose that receives an output of a fluid from the pump; a spray gun that receives the fluid from the hose; at least one sensor configured to generate information regarding a pressure output by the pump; and a controller. The controller configured to receive an output from the at least one sensor and control operation of the electric motor based on the information from the at least one sensor and based on a target pressure for the pressure output by the pump; and cease output from the pump operate while operating in a first mode by stopping rotation of the electric motor when the pressure crosses a first threshold and resume output from the pump by restarting rotation of the electric motor when the pressure crosses a second threshold. A first difference between the first threshold and the second threshold varies based on the target pressure.

According to yet another additional or alternative aspect of the disclosure, a fluid sprayer includes an electric motor that outputs rotational motion; a drive that converts the rotational motion output from the electric motor into linear reciprocating motion; a pump driven by the drive; a hose that receives an output of a fluid from the pump; a spray gun that receives the fluid from the hose; at least one sensor configured to generate information regarding a pressure output by the pump; an input interface configured to provide pressure setting information regarding a target pressure to the controller; and a controller. The controller configured to set the target pressure based on the pressure setting information; control operation of the electric motor based on the information from the at least one sensor and based on the target pressure; and remap the input interface based on an operating mode of the controller such that each increment of the input interface adjusts the target pressure by a first pressure value with the controller in a first mode and the each increment adjusts the target pressure by a second pressure value with the controller in a second mode, the first pressure value differing from the second pressure value.

According to yet another additional or alternative aspect of the disclosure, a fluid sprayer includes an electric motor that output rotational motion; a drive that converts the rotational motion output by the electric motor into linear reciprocating motion; a pump including a fluid displacer that is connected to the drive to be driven by the drive, the fluid displacer configured to move through pump cycles to pump fluid, each pump cycle including a suction stroke and a pressure stroke; a hose that receives an output of the fluid from the pump; a spray gun that receives the fluid from the hose; a least one sensor configured to generate information regarding a sensed position of the fluid displacer; and a controller configured to receive the information from the at least one sensor and control provision of electric power to the electric motor based on the sensed position of the fluid displacer.

According to yet another additional or alternative aspect of the disclosure, a fluid sprayer includes an electric motor configured to output rotational motion; a drive configured to convert the rotational motion output by the electric motor into linear reciprocating motion; a pump including a fluid displacer that is connected to the drive to be driven by the drive, the fluid displacer configured to move through pump cycles to pump fluid, each pump cycle including a suction stroke and a pressure stroke; a hose that receives an output of the fluid from the pump; a spray gun that receives the fluid from the hose; at least one sensor configured to generate information regarding a position of the fluid displacer; and a controller configured to receive the information from the at least one sensor and control provision of electric power to the electric motor based on the sensed position of the fluid displacer.

According to yet another additional or alternative aspect of the disclosure, a fluid sprayer includes an electric motor configured to output rotational motion; a drive configured to convert the rotational motion output by the electric motor into linear reciprocating motion; a pump including a fluid displacer that is connected to the drive to be driven by the drive, the fluid displacer configured to move through pump cycles to pump fluid, each pump cycle including a suction stroke and a pressure stroke; a hose that receives an output of the fluid from the pump; a spray gun that receives the fluid from the hose; at least one sensor configured to generate information regarding a position of the fluid displacer; and a controller configured to receive the information from the at least one sensor and vary a power level of electric power to the electric motor based on the sensed position of the fluid displacer.

### BRIEF DESCRIPTION OF THE DRAWINGS

FIG. 1A is a front elevational schematic block diagram of a spray system.

FIG. 1B is a side elevational schematic block diagram of a spray system.

FIG. 2 is an isometric view of a front side of a drive system.

FIG. 3 is an exploded view of a drive system.

FIG. 4 is a cross-sectional view of a drive system.

FIG. 4A is an enlarged view of portion 4A of FIG. 4.

FIG. 5 is an isometric front side view of a support frame for the drive system and displacement pump of FIG. 2.

FIG. 6A shows a cross-sectional view of a spray system.

FIG. 6B is an enlarged view of detail B in FIG. 6B.

FIG. 7 is an exploded view of various components of the spray system shown in FIG. 6A.

FIG. 8 is an isometric view of a drive system.

FIG. 9 is a cross-sectional view of the drive system shown in FIG. 8.

FIG. 10 is a schematic view of a pump.

FIG. 11 is a schematic view of a pressure range with high- and low-pressure ranges.

FIG. 12 is a schematic view of a pressure range with high- and low-pressure ranges.

FIG. 13 is a schematic view showing tolerance ranges.

FIG. 14 is a schematic diagram showing application of motor power relative to a rotational position of a drive mechanism.

FIG. 15 is a graph illustrating application of motor power relative to a position of a fluid displacer.

### DETAILED DESCRIPTION

The present disclosure is directed to a drive system for a reciprocating fluid displacement pump. The drive system of the present disclosure has an electric motor that has a rotational output that causes pumping by a pump. Some examples have a drive that is connected to the electric motor and that receives the rotational output from the motor and powers pumping by the pump. The drive can convert the rotational output into linear movement, such as reciprocating linear movement, to cause pumping by the pump. Some examples of the drive can include an eccentric driver. The drive can convert rotational output of the rotor of the motor to linear, reciprocating input to the fluid displacer of the pump. The rotor can be disposed outside of the stator to rotate about the stator such that the motor is an outer rotator motor.

A controller can control operation of the electric motor to cause pumping by the pump. The controller can be configured to cause the pump to output fluid according to a target fluid parameter. For example, the target fluid parameter can be a target pressure, target flow rate, among other options. One or more sensors can generate information for use by the controller in controlling output of the spray fluid. The one or more sensors can include sensors configured to generate information regarding the fluid output by the pump, such as pressure sensors, flow meters, etc. The one or more sensors can include sensors configured to generate information regarding the position of one or more components of the fluid sprayer. For example, one or more sensors can generate information regarding a position of the motor (e.g., rotational position of the rotor of the motor), a position of the drive (e.g., rotational position of a rotating component of the drive), a position of the fluid displacer (e.g., a linear position of the fluid displacer), etc. The position of the fluid displacer can be determined by direct sensing (e.g., by sensing a position of a shaft of the fluid displacer) or by indirect sensing (e.g., directly sensing the rotational position of the rotor and determining the position of the fluid displacer based on the sensed position of the rotor).

The controller can control operation of the electric motor based on the position of the fluid displacer. The spray system can include a reciprocating fluid displacer (e.g., a piston or diaphragm, among other options). The controller can control operation of the electric motor based on the sensed position of the fluid displacer within a pump stroke. Reciprocating fluid displacers change stroke direction during operation. The controller can control operation of the electric motor based on the position of the fluid displacer relative to the changeover points of the fluid displacer. The controller can be configured to vary a speed of the electric motor based on the position of the fluid displacer. The controller can be configured to vary the power supplied to electric motor based on the position of the fluid displacer.

The controller can control operation of the electric motor based on the target pressure. The controller can control starting and stopping of the electric motor based on a tolerance range about the selected target pressure. The controller can stop pumping by the pump, such as by stopping the electric motor, based on the sensed pressure exceeding the target pressure by a threshold amount and can start pumping by the pump, such as by powering the electric motor, based on the sensed pressure falling below the target pressure by a threshold amount. The controller can implement different tolerance ranges depending on the selected target pressure.

The controller can be configured to operate in different operating modes. The controller can vary control of the electric motor based on the operating mode of the controller. For example, the controller can implement a differently sized tolerance range for starting and stopping the electric motor in the different operating modes. For example, the controller can implement a narrower tolerance range when operating in a low-pressure mode and can implement a larger tolerance range when operating in a high-pressure mode.

The controller can be configured to be selectively placed in one of multiple potential operating modes. The operating modes can be associated with pressure ranges. The controller can be configured to operate in a mode when the target pressure falls within a pressure range associated with that operating mode. For example, a low-pressure range can be associated with a first mode and a high-pressure range can be associated with a second mode. The multiple pressure ranges can overlap such that the controller can be operated in multiple of the operating modes for a single target pressure.

The spray system can include an input interface that provides pressure setting information to the controller. The pressure setting information provides the target pressure to the controller. The input interface is manipulable by a user to allow the user to provide the desired target pressure to the controller. For example, the input interface can be configured as one or more of a switch, dial, knob, slider, lever, crank, graphical user interface, among other options. The user interface can be adjustable between a minimum pressure state, associated with a smallest pressure setting within a pressure range, and a maximum pressure state, associated with a largest pressure setting within a pressure range. The controller can adjust the target pressure as the input interface is adjusted between the minimum and maximum pressure states.

The controller can interpret the input received from the input interface depending on the operating state of the controller. The controller can adjust the target pressure by a first pressure valve based on an incrementation of the input interface while operating in a first mode, The controller can then adjust the target pressure by a second pressure valve different from the first pressure value based on an incrementation of the input interface while operating in a second mode, Remapping the input from the input interface allows a single input interface to provide target parameter information to the controller regardless of the operating mode of the controller.

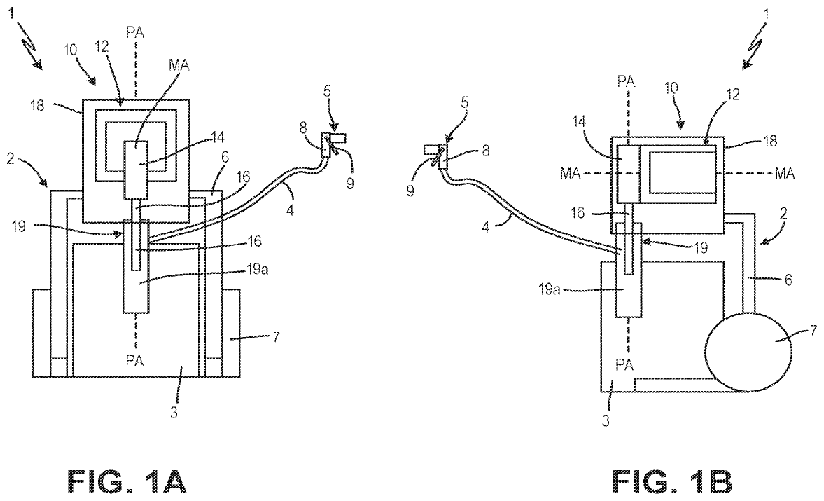

FIG. 1A is a front elevational schematic block diagram of spray system 1. FIG. 1B is a side elevational schematic block diagram of spray system 1. FIGS. 1A and 1B are discussed together. Support 2, reservoir 3, supply line 4, spray gun 5, and drive system 10 are shown. Drive system 10 includes electric motor 12, drive mechanism 14, pump frame 18, and displacement pump 19. Support 2 includes support frame 6 and wheels 7. Fluid displacer 16 and pump body 19a of displacement pump 19 are shown. Spray gun 5 includes a handle 8 and trigger 9.

Spray system 1 is a system for applying sprays of various fluids, examples of which include paint, water, oil, stains, finishes, aggregate, coatings, and solvents, amongst other options, onto a substrate. Drive system 10, which can also be referred to as a pump assembly, can generate high fluid pumping pressures, such as about 3.4-69 megapascal (MPa) (about 500-10,000 pounds per square inch (psi)) or even higher. In some examples, the pumping pressures are in the range of about 20.7-34.5 MPa (about 3,000-5,000 psi). High fluid pumping pressure is useful for atomizing the fluid into a spray for applying the fluid to a surface.

Drive system 10 is configured to draw spray fluid from reservoir 3 and pump the fluid downstream to spray gun 5 for application on the substrate. Support 2 is connected to drive system 10 and supports drive system 10 relative to reservoir 3. Support 2 can receive and react loads from drive system 10. For example, support frame 6 can be connected to pump frame 18 to react the loads generated during pumping. In the example shown, wheels 7 are connected to support frame 6 to facilitate movement between job sites and within a job site.

Pump frame 18 supports other components of drive system 10. Motor 12 and displacement pump 19 are connected to pump frame 18. Motor 12 is an electric motor having a stator and a rotor. Motor 12 can be configured to be powered by any desired power type, such as direct current (DC), alternating current (AC), and/or a combination of direct current and alternating current. The rotor is configured to rotate about a motor axis MA in response to current, such as direct current or alternating current signals, through the stator. In some examples, the rotor can rotate about the stator such that motor 12 is an outer rotator motor.

Drive mechanism 14 is connected to motor 12 to be driven by motor 12. Drive mechanism 14 can also be referred to as a drive. Drive mechanism 14 receives a rotational output from motor 12 and drives movement of pump 19 to cause pumping by pump 19. For example, drive 14 can convert that rotational output into a linear input along pump axis PA. In the example shown, drive mechanism 14 is connected to fluid displacer 16 to drive reciprocation of fluid displacer 16 along pump axis PA. As illustrated in FIG. 1B, motor axis MA is disposed transverse to pump axis PA. More specifically, motor axis MA can be orthogonal to pump axis PA. In the example shown, fluid displacer 16 reciprocates within a pump body 19a, such as cylinder 94 discussed below, to pump spray fluid from reservoir 3 to spray gun 5 through supply line 4.

In some examples, motor 12, drive mechanism 14, and fluid displacer 16 can be disposed coaxially such that motor axis MA and pump axis PA are coaxial. For example, pump 19 can be configured as a rotor-stator pump in which a rotating component is moved relative to a stationary component to pump the fluid, such as a helical rod being rotated within a lobed sleeve.

During operation, the user can maneuver drive system 10 to a desired position relative the target substrate by moving support 2. For example, the user can maneuver drive system 10 by tilting support frame 6 on wheels 7 and rolling drive system 10 to a desired location. In some examples, a handle can extend from drive system 10 and the user can maneuver drive system 10 within a job site or between job sites by grasping the handle and carrying drive system 10. Displacement pump 19 is disposed to draw spray fluid from reservoir 3. In some examples, displacement pump 19 can extend into reservoir 3. Motor 12 provides the rotational input to drive mechanism 14 and drive mechanism 14 provides an input to fluid displacer 16 to cause drive fluid displacer 16. Fluid displacer 16 draws the spray fluid from reservoir 3 and drives the spray fluid downstream through supply line 4 to spray gun 5.

The user can manipulate spray gun 5 by grasping the handle 8 of the spray gun 5, such as with a single hand of the user. The user causes spraying by actuating trigger 9. Actuating the trigger 9 can open a valve within the spray gun 5 to allow release of the pressurized fluid from the spray gun 5. The fluid can be emitted through a nozzle that atomizes the spray fluid. The nozzle can shape the spray fluid into a desired pattern, such as a fan, cone, etc. In some examples, the pressure generated by drive system 10 atomizes the spray fluid exiting spray gun 5 to generate the fluid spray. In some examples, spray gun 5 is an airless sprayer.

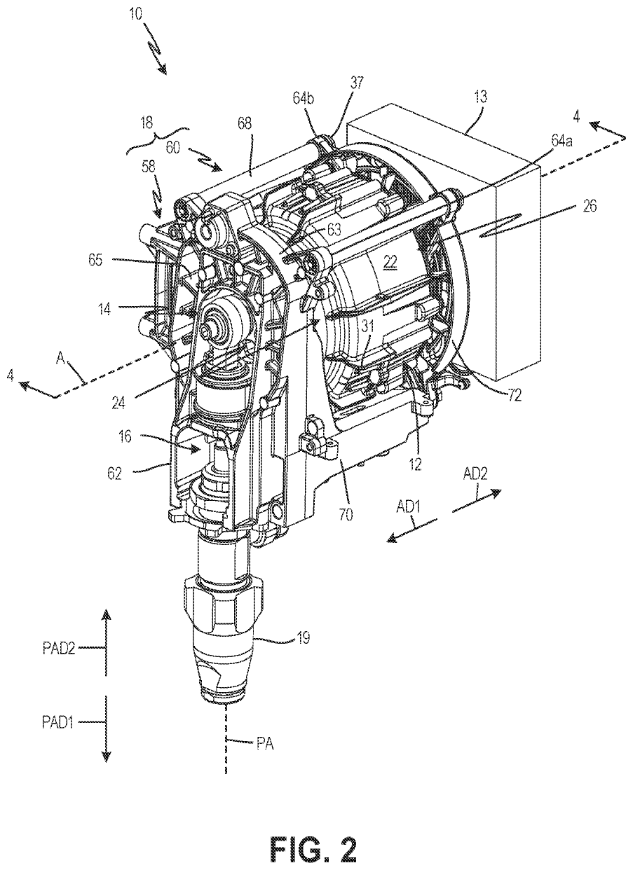

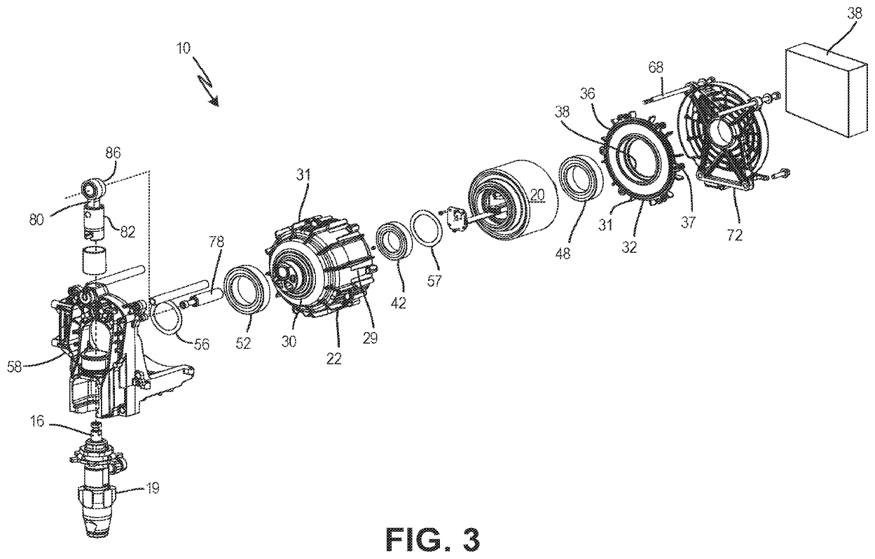

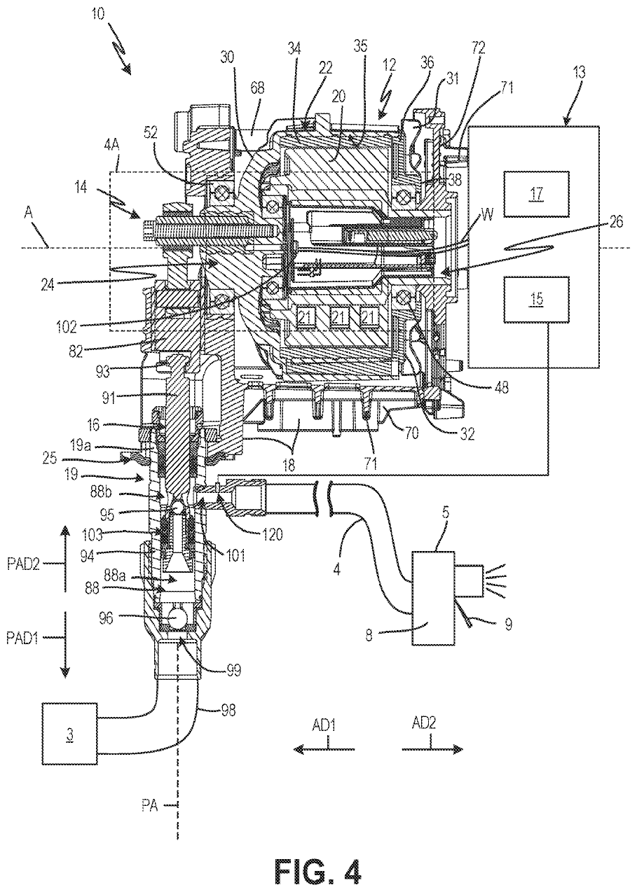

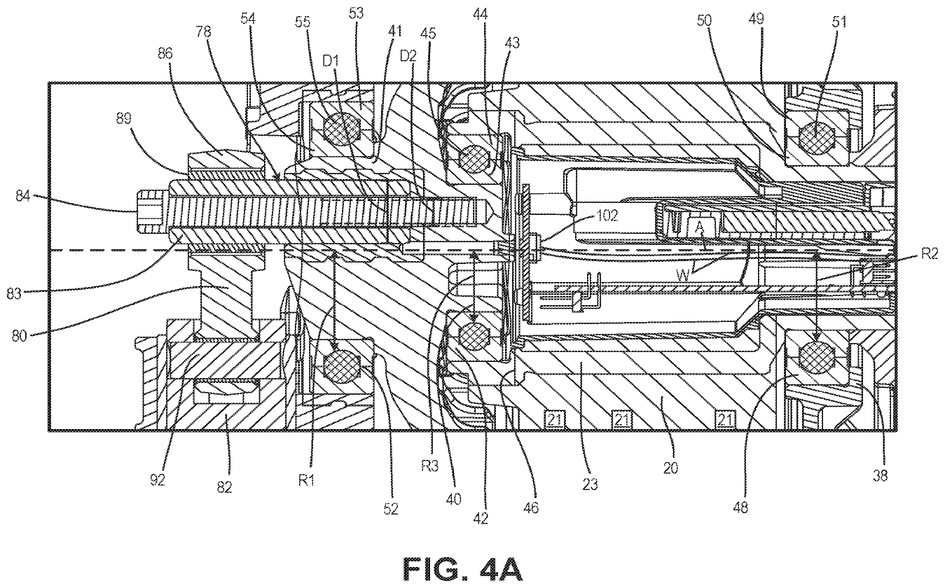

FIG. 2 is an isometric view of a front side of drive system 10. FIG. 3 is an exploded view of drive system 10. FIG. 4 is a cross-sectional view of drive system 10. FIG. 4A is an enlarged view of portion 4A of FIG. 4. FIG. 5 is an isometric front side view of a support frame for the drive system and displacement pump of FIG. 2. Electric motor 12, control panel 13, drive mechanism 14, fluid displacer 16, support frame 18, and displacement pump 19 are shown. FIGS. 2-4 illustrate one embodiment of drive mechanism 14 coupled to an outer rotor electric motor 12 and configured to power reciprocation of a fluid displacement member of pump 19. FIG. 5 illustrates one embodiment of support frame 18 configured to mechanically support electric motor 12 and pump 19.

Electric motor 12 includes stator 20, rotor 22, and axle 23. In the example shown, electric motor 12 can be a reversible motor in that stator 20 can cause rotation of rotor 22 in either of two rotational directions about motor axis A (e.g., clockwise or counterclockwise), which can be the same as motor axis MA shown in FIGS. 1A and 1B. Electric motor 12 is disposed on axis A and extends from first end 24 to second end 26. First end 24 can be an output end configured to provide a rotational output from motor 12. Second end 26 can be an electrical input end configured to receive electrical power to provide to stator 20 to power operation of motor 12. For example, one or more wires w can extend into electrical input end 26 and to stator 20 to provide electrical power to operate stator 20.

Rotor 22 can be formed of a housing, having cylindrical body 28 disposed between first wall 30 and second wall 32. Cylindrical body extends axially relative to motor axis A between first and second walls 30, 32. First and second walls 30, 32 extend substantially radially inward from cylindrical body 28 and towards motor axis A. Cylindrical body 28 and/or first and/or second walls 30, 32 can have fins 31 projecting radially and/or axially and/or cylindrically from and/or along body 28 and/or walls 30, 32. Rotor 22 includes permanent magnet array 34 disposed on inner circumferential face 35. Inner circumferential face 35 can be the radially inner side of cylindrical body 28. Second wall 32 can have axially extending flange 36 configured to be received in an inner diameter of cylindrical body 28. Second wall 32 can be fastened to cylindrical body 28 by fasteners, adhesive, welding, press-fit, interference fit, or other desired manners of connection. For example, bolts 37 or another fastener can connect wall 32 and cylindrical body 28. Second wall 32 can have radially extending annular flange 38 at an inner diameter opening. Annular flange 38 can be rotationally coupled to axle 23, such as by bearing 48. Annular flange 38 can at least partially define a receiving shoulder for receiving the outer race 49 of bearing 48 and preloading bearing 48. Rotor 22 can include a plurality of cylindrical projections 40, 41 extending axially from first wall 30. Cylindrical projections 40, 41 can rotationally couple rotor 22 to stator 20 and support frame 18.

Bearing 42, having inner race 43, outer race 44, and rolling elements 45, rotationally couples rotor 22 to stator 20 at axle end 46 opposite second end 26. Bearing 48, having outer race 49, inner race 50, and rolling elements 51, rotationally couples rotor 22 to stator 20 at second end 26.

Support frame 18 is mechanically coupled to rotor 22 at output end 24 via bearing 52, having outer race 53, inner race 54, and rolling elements 55. Rotor 22 can be received in support frame 18, such that a portion of rotor 22 extends into support frame 18 and is radially surrounded by a portion of support frame 18. Bearing 52 can be disposed between rotor 22 and support frame 18 such that both bearing 52 and support frame 18 are positioned radially outward from the portion of rotor 22 at output end 24. Wave spring washer 56 can be disposed between bearing 52 and support frame 18. An additional wave spring washer 57 can be disposed between bearing 42 and axle 23.

Support frame 18 includes pump frame 58 (best seen in FIG. 5) and support member 60. It is understood that the term member can refer to a single piece or multiple pieces fixed together. Pump frame 58 mechanically supports pump 19 and electric motor 12. Pump frame 58 is mechanically coupled to rotor 22 at output end 24 via bearing 52. Pump frame 58 can include pump housing portion 62, outer frame body 63, projections 64a, support ribs 65, handle attachment 66, and hub 67. Support member 60 provides a frame for motor 12. Support member 60 is mechanically coupled pump frame 58 and motor 12 and supports both pump and electric motor reaction forces. Support member 60 extends from pump frame 58 at output end 24 to axle 23 at electrical input end 26. Support member 60 can include connecting members 68, base plate 70, and frame member 72. Frame member 72 can include projections 64b, support posts 73, hub 74, ribs 75, and support rings 76. Base plate 70 can include support posts 71. Pump frame 58 and frame member 72 are disposed on opposite axial ends of motor 12 relative to axis A. A first plane that motor axis A is normal to at output end 24 can extend through pump frame 58. A second plane that motor axis A is normal to at input end 26 can extend through frame member 72. The two planes are spaced axially apart along motor axis A and do not intersect.

Control panel 13 can be mounted to and supported by support frame 18. Specifically, control panel 13 can be mounted to frame member 72 on an opposite axial side of frame member 72 from motor 12 relative to axis A, such that frame member 72 separates control panel 13 from motor 12 and is disposed directly between control panel 13 and motor 12 along axis A. Control panel 13 can be cantilevered from motor 12 via frame member 72. Control panel 13 can be cantilevered from support frame 18. In the example shown, control panel 13 is mounted to frame member at control support posts 73. Control support posts 73 extend axially from frame member 72 and away from motor 12. Control support posts 73 can provide directly contact between thermally conductive elements of frame member 72 and control panel 13, such as a metal-to-metal contact, to facilitate heat transfer, as discussed in more detail below.

Control panel 13 can include and/or support controller 15 and various other control and/or electrical elements of drive system 10. Controller 15 is operably connected to motor 12, electrically and/or communicatively, to control operation of motor 12 thereby controlling pumping by displacement pump 19. Controller 15 can be of any desired configuration for controlling pumping by displacement pump 19 and can include control circuitry and memory. Controller 15 is configured to store software, store executable code, implement functionality, and/or process instructions. Controller 15 is configured to perform any of the functions discussed herein, including receiving an output from any sensor referenced herein, detecting any condition or event referenced herein, and controlling operation of any components referenced herein. Controller 15 can be of any suitable configuration for controlling operation of drive system 10, controlling operation of motor 12, gathering data, processing data, etc. Controller 15 can include hardware, firmware, and/or stored software, and controller 15 can be entirely or partially mounted on one or more boards. Controller 15 can be of any type suitable for operating in accordance with the techniques described herein. While controller 15 is illustrated as a single unit, it is understood that controller 15 can be disposed across one or more boards. In some examples, controller 15 can be implemented as a plurality of discrete circuitry subassemblies. In some examples, controller 15 can be implemented across one or more locations such that one or more, but less than all, components forming controller 15 are disposed in and/or supported by control panel 13. In some examples, controller 15 is disposed at locations other than control panel 13.

Controller 15 can include any one or more of a microprocessor, a digital signal processor (DSP), an application specific integrated circuit (ASIC), a field-programmable gate array (FPGA), or other equivalent discrete or integrated logic circuitry. Computer-readable memory can be configured to store information during operation. The computer-readable memory can be described, in some examples, as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). Computer-readable memory of control module 14 and/or motor controller 22 can include volatile and non-volatile memories. Examples of volatile memories can include random access memories (RAM), dynamic random access memories (DRAM), static random access memories (SRAM), and other forms of volatile memories. Examples of non-volatile memories can include magnetic hard discs, optical discs, flash memories, or forms of electrically programmable memories (EPROM) or electrically erasable and programmable (EEPROM) memories. In some examples, the memory is used to store program instructions for execution by the control circuitry. The memory, in one example, is used by software or applications running on the control module 14 or motor controller 22 to temporarily store information during program execution.

Control panel 13 is further shown as including user interface 17. User interface 17 can be configured as an input and/or output device. User interface 17 can be disposed at locations other than control panel. User interface 17 can be configured to receive inputs and/or provide outputs. Examples of user interface 17 can include one or more of a sound card, a video graphics card, a speaker, a display device (such as a liquid crystal display (LCD), a light emitting diode (LED) display, an organic light emitting diode (OLED) display, etc.), a touchscreen, a keyboard, a mouse, a joystick, a dial, a switch, a graphical user interface (GUI), or other type of device for facilitating input and/or output of information in a form understandable to users or machines. While user interface 17 is shown as being formed as a portion of control panel 13, it is understood that user interface 17 can, in some examples, be disposed remote from control panel 13 and communicatively connected to other components, such as controller 15.

Controller 15 can be configured to control operation of the motor 12 based on a target pressure for the fluid output by the pump 19. In some examples, user interface 17 is formed as and/or includes an input interface by which the target pressure can be provided to the controller 15. The input interface can be actuatable between a minimum pressure state, corresponding with a minimum pressure setting for the pump 19, and a maximum pressure state, corresponding with a maximum pressure setting for the pump 19. The user can input a parameter output setting at user interface 17. The input interface is configured to provide parameter setting information to the controller, the parameter setting information indicating the target parameter for output by the pump 19, such as pressure or flow. In some examples, the user interface 17 is configured to provide pressure setting information to the controller 15, the pressure setting information indicating a target pressure for the output from the pump 19. The input interface can be configured to receive an input from a user and provide information regarding the target pressure to the controller 15. For example, the input interface can be configured as a switch, dial, GUI, knob, slider, joystick, etc. Incrementing the input interface between the minimum and maximum setting states changes the target pressure. Incrementing the input interface towards the maximum state increases the target pressure and incrementing the input interface towards the minimum state decreases the target pressure. The input interface can be incremented between discrete positions or can be configured as infinitely adjustable between the minimum and maximum pressure states.

Drive mechanism 14 is connected to motor 12 and pump 19. Drive mechanism 14 is configured to receive the rotational output from rotor 22 and convert that rotational output into a movement input to fluid displacer 16. In the example shown, drive mechanism 14 includes eccentric driver 78, drive member 80, and drive link 82. Eccentric driver 78 can include sleeve 83 and fastener 84. Drive member 80 can include follower 86 and bearing member 89. Drive link 82 can include connecting slot 90 and pin 92.

In the example shown, pump 19 includes fluid displacer 16 configured to reciprocate within cylinder 94 to pump fluid. In the example shown, fluid displacer 16 is a piston configured to reciprocate on pump axis PA to pump fluid. It is understood, however, that fluid displacer 16 can be of other desired configurations, such as a diaphragm, plunger, etc. among other options. In the example shown, fluid displacer 16 includes shaft 91 and connector 93. Pump 19 includes cylinder 94 that is connected to support frame 18. Check valves 95, 96 regulate flow through pump 19. In the example shown, check valve 95 is mounted to the piston forming fluid displacer 16 to travel with the piston. Pump 16 is configured to draw fluid from reservoir 3 through line 98 and to output fluid to spray gun 5 through line 4.

Spray gun 5 is configured to output an atomized spray of the spray fluid. Spray gun 5 is configured as a handheld sprayer in the example shown, including handle 8 configured to be grasped by a single hand of a user and trigger 9 that is configured to be actuated by the user to open a valve in spray gun 5 to allow for spraying of the spray fluid.

Support frame 18 supports motor 22 and pump 19. As discussed in further detail below, support frame 18 is dynamically connected to rotor 22 by a bearing interface and statically connected to stator 20. Support frame 18 is statically connected to pump 19. Electric motor 12 is dynamically connected to support frame 18 via rotor 22 and statically connected to support frame 18 via stator 20. Electric motor 12 is dynamically connected to pump 19 via fluid displacer 16. Pump 19 is statically connected to support frame 18 and dynamically connected to electric motor 12.

In the example shown, motor 12 is an electric motor having inner stator 20 and outer rotor 22. Motor 12 can be configured to be powered by any desired power type, such as direct current (DC), alternating current (AC), and/or a combination of direct current and alternating current. Stator 20 includes armature windings 21 and rotor 22 includes permanent magnets 34. Rotor 22 is configured to rotate about motor axis A in response to current signals through stator 20. Rotor 22 is connected to the fluid displacer 16 at an output end 24 of rotor 22 via drive mechanism 14. Drive mechanism 14 receives a rotary output from rotor 22 and provides a linear, reciprocating input to fluid displacer 16. Support frame 18 mechanically supports electric motor 12 at the output end 24 and mechanically supports reciprocating fluid displacement pump 19 by the connection between cylinder 94 and pump 19. Support frame 18 at least partially houses fluid displacer 16 of reciprocating pump 19. In the example shown, cylinder 94 is mounted to pump frame 58 by clamp 25 receiving a portion of the support frame between a first member of the clamp 25 and a second member of the clamp 25. For example, flange 59 can be received between the two members of clamp 25.

Stator 20 defines axis A of electric motor 12. Stator 20 is disposed around and supported by axle 23. Axle 23 is mounted to be stationary relative to motor axis A during operation. Stator 20 is fixed to axle 23 to maintain a position of stator 20 relative to motor axis A. Power can be supplied to armature windings 21 by electrical connection made at or through electrical input end 26 of electric motor 12. Each winding 21 can be a part of a phase of the motor 12. In some examples, motor 12 can include three phases. The power can be provided to each phase according to electrically offset sinusoidal waveforms. For example, a motor with three phases can have each phase receive a power signal 120-degrees electrically offset from the other phases. Axle 23 can be a hollow shaft open to electrical input end 26 for receiving electrical wiring from outside of motor 12. In alternative embodiments, axle 23 can be solid, can have a key, can be D-shaped, or other similar design. In some embodiments, axle 23 can be defined by a plurality of cylindrical cross-sections taken perpendicular to axis A that are of varying diameters to accommodate mechanical coupling with support frame 18 at electrical input end 26 of axle 23 and coupling with rotor 22 at an axially opposite end 46 of axle 23. For example, a first end of axle 23 can be disposed radially between stator 20 and rotor 22 and have a larger diameter than the axially opposite end 46 for receiving electrical inputs.

Rotor 22 is disposed coaxially with stator 20 and around stator 20 and is configured to rotate about axis A. Rotor 22 can be formed from a housing having cylindrical body 28 extending between first wall 30 and second wall 32, such that rotor 22 is positioned to extend around three sides of stator 20. Rotor 22 includes a permanent magnet array 34. Permanent magnet array 34 can be disposed on an inner circumferential face 35 of cylindrical body 28. An air gap separates permanent magnet array 34 from stator 20 to allow for rotation of rotor 22 with respect to stator 20. Rotor 22 can overlap stator 20 and axle 23 over a full radial extent of stator 20 and axle 23 at output end 24 of electric motor 12. In some examples, rotor 22 can fully enclose stator 20 and axle 23 at output end 24 of electric motor 12. Rotor 22 can partially or fully overlap stator 20 over a radial extent of stator 20 at electrical input end 26 of electric motor 12. Second wall 32 extends from cylindrical body 28 radially inward toward axle 23. Axle 23 can extend through an opening in second wall 32 concentric with axle 23 and can extend axially outward of second wall 32 in axial direction AD2. Second wall 32 is radially separated from axle 23, by bearing 48 in the example shown, at electrical input end 26 of electric motor 12 to allow rotation of rotor 22 with respect to axle 23.

Generally, stator 20 generates electromagnetic fields that interact with a plurality of magnetic elements of rotor 22 to rotate rotor 22 about stator 20. More specifically, stator 20 includes a plurality of windings 21 that generate electromagnetic fields. The electromagnetic fields generated by windings 21 are radially outward facing, toward rotor 22. Rotor 22 includes either a plurality of permanent magnets 34 circumferentially arrayed within rotor 22, or a plurality of windings that temporarily magnetize metallic material both of which are circumferentially arrayed within rotor 22. In either configuration of rotor 22, the electromagnetic fields generated by the plurality of solenoids 21 of stator 20 attract and/or repel the magnetic elements of rotor 22 to rotate rotor 22 about stator 20.

First and/or second walls 30, 32 of rotor 22 can be formed integrally with cylindrical body 28 or can be mechanically fastened to cylindrical body 28. The mechanical connection to cylindrical body 28 can be formed in any desired manner, such as by fasteners, interference fitting, welding, adhesive, etc. Rotor 22 is formed such that a closed end of rotor 22 is oriented towards the axis PA of reciprocation of pump 19 and such that an open end of rotor 22 in oriented towards control panel 13. The closed end of rotor 22 (formed by wall 30) faces the pump 19 and the open end (formed by wall 32, that is open to facilitate electrical connections) is oriented away from pump 19 along the motor axis A. The open end of rotor 22 is oriented towards control panel 13. In the example shown, the opening through wall 32 is open to the space directly between control panel 13 and motor 22.

First wall 30 can have a tapered thickness and/or can be angled between axle 23 and cylindrical body 28. First wall 30 can have a tapered thickness with thickness increasing in a radial direction from cylindrical body 28 toward axis A. In the example shown, the axially-oriented face of first wall 30 is contoured such that first wall 30 is domed outwards in first axial direction. In the example shown, first wall 30 is integrally formed with cylindrical body 28.

In the example shown, second wall 32 is formed separately from cylindrical body 28 and connected to cylindrical body 28. In the example shown, second wall 32 is fastened to an outer diameter portion of cylindrical body 28 with a plurality of fasteners, more specifically by bolts 37. Second wall 32 can include axially extending flange 36 at a radially outer end, which can form a sliding fit with an inner diameter of cylindrical body 28. Axially extending flange 36 aligns second wall 32 with cylindrical body 28 to provide proper alignment during assembly and to prevent rotor 22 from being unbalanced due to misalignment. Axially extending flange 36 facilitates concentricity between cylindrical body 28 and second wall 30. Axially extending flange 36 can be annular. Cylindrical body 28 and/or one or both of first and second walls 30, 32 can include one or more of fins 31 that extend outward (axially and/or radially) to push air as rotor 22 rotates. Fins 31 can be used, for example, to direct cooling air toward control panel 13. Fins 31 can be formed from thermally conductive material to act as heat sinks to conduct heat away from motor 12.

Bearings 42, 48, and 52 are disposed coaxially on rotational axis A, such that rotating members of bearings 42, 48, and 52 rotate on rotational axis A. Bearings 42, 48, and 52 can be substantially similar in size or can vary in size to support differing loads and to accommodate space constraints. Bearings 42 and 48 can be substantially similar in size, while bearing 52 at output end 24 can be larger to accommodate reciprocating load received by rotor 22 at output end 24. In some examples, all three bearings 42, 48, 52 can have different sizes. In the example shown, the end bearing 52 is larger than the end bearing 48, and the end bearing 48 is larger than the intermediate bearing 42. Rolling elements of bearings 42, 48, and 52 can vary in radial position from axis A. Rolling elements 55 of bearing 52 can be disposed at a first radius RI from rotational axis A of electric motor 12, rolling elements 51 of bearing 48 can be disposed at a second radius R2 from rotational axis A, and rolling elements 45 of bearing 42 can be disposed at a third radius R3 from rotational axis A. As illustrated in FIG. 4A, first radius RI can be greater that a second radius R2 and third radius R3 can be greater the second radius R2 and less than the first radius R1. In some examples, second radius R2 is one of greater than and equal to third radius R3. First wall 30 can be rotationally coupled to a radially inner side of axle 23 via bearing 42 at axle end 46. Bearing 42 includes inner race 43, outer race 44, and rolling elements 45. In some examples, bearing 42 can be a roller or ball bearing in which rolling elements 45 are formed by cylindrical members or balls. First wall 30 can be coupled to inner race 43. Stator 20 can be coupled to outer race 44, such as by axle 23 interfacing with outer race 44. Rolling elements 45 allow rotation of rotor 22 with respect to stator 20. Bearing 42 supports rotor 22 rotationally relative to stator 20 and maintains the air gap between permanent magnet array 34 and stator 20, thereby balancing motor 12. Bearing 42 can be provided to ensure that stator 20 and rotor 22 deflect the same amount through each pump cycle, such that with each up-down pump load, the air gap between stator 20 and rotor 22 is maintained and rotor 22 does not contact stator 20. Bearing 42 minimizes the unsupported length of rotor 22 and provides an intermediate support between bearing 52 and bearing 48. In some examples, bearing 42 can support torque load generated by electric motor 12. Bearing 42 can primarily align stator 20 and rotor 22 while experiencing minimal pump reaction loads. The radius R3 of bearing 42 can be determined by the size of axle 23 at axle end 46 as bearing 42 is positioned inside axle 23.

Components can be considered to radially overlap when the components are disposed at a common position along an axis (e.g., along the motor axis A for axle 23 and wall 30) such that a radial line projecting that axis extends through each of those radially overlapped components. Similarly, components can be considered to axially overlap when the components are disposed at common positions spaced radially from the axis (e.g., relative to motor axis A for axle 23 and wall 30) such that an axial line parallel to the axis extends through each of those axially overlapped components.

First wall 30 of rotor 22 can extend into axle 23 at output end 24 such that a portion of axle 23 and a portion of first wall 30 axially overlap. As such, an axial line parallel to axis A can extend through each of first wall 30 and axle 23. Cylindrical projection 40 of rotor 22 can extend in axial direction AD2 from output end 24 of motor 12 and into axle 23 at axle end 46. As such, cylindrical projection 40 extends from a front end of the housing of rotor 22 and axially away from pump frame 58. Cylindrical projection 40 is coaxial with rotor 22 and stator 20 on rotational axis A and rotates about rotational axis A. Cylindrical projection 40 can extend into axle 23 such that cylindrical projection 40 radially overlaps with axle 23. As such, a radial line extending from axis A can pass through each of cylindrical projection 40 and axle 23. Cylindrical projection 40 is rotationally coupled to axle 23 by bearing 42. An outer diameter surface of cylindrical projection 40 can be coupled to inner race 43, such that rotor 22 rides inside of bearing 42. Axle 23 can be coupled to outer race 44. In some embodiments, at least a portion of each of cylindrical projection 40 and bearing 42 can radially overlap a portion of permanent magnet array 34 and, in some examples, stator 20. In an alternative embodiment, first wall 30 can be rotationally coupled to an outer diameter of axle 23 such that rotor 22 is coupled to an outer race 44 and axle 23 is coupled to an inner race 43.

Rotor 22 can be rotationally coupled to stator 20 at electrical input end 26 via bearing 48. Bearing 48 includes outer race 49, inner race 50, and rolling elements 51. Rotor 22 can be coupled to outer race 49 and axle 23 can be coupled to inner race 50. Rolling elements 51 allow rotation of rotor 22 with respect to stator 20 such that rotor 22 rides outside of bearing 48. In some examples, bearing 48 can be a roller or ball bearing in which rolling elements 51 are cylindrical members or balls. Second wall 32 can be coupled to an outer diameter surface of outer race 49 and can extend around an axially outer end face of outer race 49. Second wall 32 can include annular flange 38, which projects radially inward from rotor 22 towards axis A. Annular flange 38 can extend radially inward relative to the outer diameter surface of outer race 49. Flange 38 can axially overlap and abut the axially outer end face of outer race 49. Flange 38 can extend to axially overlap and abut a full circumferential axially outer end face of outer race 49. Axle 23 can extend through rotor 22 at electrical input end 26 and can project axially outward of bearing 48 in axial direction AD2 to allow for coupling of axle 23 with support frame 18, such as via support member 60. The radius R2 of bearing 48 can be determined by the size of axle 23 at input end 26 and to react the pump loads generated during operation.

Bearing 52 can support both dynamic motor loads and the pump reaction forces generated by reciprocation of fluid displacer 16 during pumping. Bearing 48 can support both dynamic motor loads and the pump reaction loads generated by reciprocation of fluid displacer 16 during pumping.

The pump reaction forces experienced by bearing 48 are in a generally opposite axial direction (PAD1, PAD2) as compared to the pump reaction forces simultaneously experienced by bearing 52. For example, bearing 52 experiences an upward pump reaction force caused by fluid displacer 16 being driven through a downstroke, while bearing 48 experiences a downward pump reaction force during to the downstroke. Similarly, bearing 52 experiences a downward pump reaction force caused by fluid displacer 16 being driven through an upstroke, while bearing 54 experiences an upward pump reaction force during the upstroke. The pump reaction loads are transmitted through bearing 52 to support frame 18.

One or both of bearings 42 and 48 can be omitted from drive system 10 in some embodiments. In such embodiments, rotor 22 can be fully separated from and free of mechanical coupling with stator 20 and axle 23 on all three sides. First wall 30 on output end 24 can extend across axis A to fully cover a radial extent of stator 20 and axle 23 at output end 24, while maintaining axial and radial separation from stator 20 and axle 23. Axle 23 can extend through second wall 32 and can be radially separated therefrom by a gap to allow rotation of rotor 22 with respect to axle 23 in the absence of bearing 48. In such configurations, rotation of rotor 22 can be supported by a bearing coupling between rotor 22 and pump frame 58 (discussed further herein), alone or in combination with one of bearings 42 and 48.

Rotor 22 is mechanically coupled to support frame 18 at output end 24 via bearing 52. Bearing 52 includes inner race 54, outer race 53, and rolling elements 55. Bearing 52 can be a roller or ball bearing, in which rolling elements 55 are cylindrical members or balls. Rotor 22 can be received in pump frame 58, such that a portion of rotor 22 extends into pump frame 58 and is radially surrounded by a portion of pump frame 58. Bearing 52 can be disposed between rotor 22 and pump frame 58 such that both bearing 52 and pump frame 58 are positioned radially outward from rotor 22 at output end 24. Rotor 22 can be coupled to inner race 54 and pump frame 58 can be coupled to outer race 53, such that rotor 22 rides inside of bearing 52. Rolling elements 55 allow rotational motion of rotor 22 relative to pump frame 58.

Bearing 52 is positioned proximate drive mechanism 14 and most directly experiences the pump load generated by reciprocation of fluid displacer 16 and transmitted via rotor 22 and, more specifically, cylindrical projection 41 to which drive mechanism 14 is coupled. Bearing 52 can have a relatively large radius RI as compared to other motor support bearings (e.g., bearings 42, 48) to accommodate both pump load generated by reciprocation of fluid displacer 16 and torque load generated by electric motor 12. Bearing 52 can support both dynamic motor load including torque load generated by electric motor 12 and an up-down pump load generated substantially along pump axis PA by reciprocation of fluid displacer 16 during pumping. Such pump reaction loads can be experienced by electric motor 12 and are particularly noticeable in direct drive configurations, which exclude intermediate gearing between rotor 22 and drive mechanism 14. For example, the drive system 10 shown in FIGS. 2-4 has a direct drive configuration.

Rotor 22 can include cylindrical projection 41 extending in axial direction AD1 from wall 30 of rotor 22. Cylindrical projection 41 can extend axially outward in direction AD1 from the output end 24 or front end of electric motor 12 and can extend into an opening in pump frame 58. Cylindrical projection 41 is centered on rotational axis A and rotates about rotational axis A with rotor 22. Bearing 52 can be disposed on an outer diameter portion of cylindrical projection 41 to couple rotor 22 to pump frame 58 by the cylindrical projection 41. Cylindrical projection 41 can be coupled to inner race 54 and pump frame 58 can be coupled to outer race 53. Inner race 54 can be disposed on an outer diameter surface of cylindrical projection 41. Rolling elements 55 allow rotational motion of rotor 22 relative to pump frame 58. Cylindrical projection 41 can extend at least partially into pump frame 58 along axis A. In some examples, cylindrical projection 41 does not extend fully through pump frame 58 such that cylindrical projection 41 does not project in the first axial direction AD1 beyond the structure of pump frame 58. In some examples, cylindrical projection 41 does extend fully through pump frame 58 such that a portion of cylindrical projection 41 projects in axial direction AD1 beyond the structure of pump frame 58.

As used herein, the term “axially outer” refers to a surface facing outward of electric motor 12 (i.e., away from stator 20 along axis A) and the term “axially inner” refers to a surface facing an inner portion (i.e., towards stator 20 along axis A) of electric motor 12. A portion of an axially outer end face of wall 30 can axially overlap with and abut an axially oriented end face of inner race 54 (oriented in axial direction AD2 in the example shown). Wall 30 can thereby form a support for bearing 52. The portion of the axially outer end face of wall 30 can extend radially outward from cylindrical projection 41 and fully annularly around cylindrical projection 41 to axially overlap and abut a full circumferential axially inner end face of inner race 54. For example, wall 30 can include an annular axially extending projection circumscribing cylindrical projection 41 and extending approximately equal to or less than a height of inner race 54 to interface with inner race 54. The projection is configured to fix an axially inner location of bearing 52 and to axially separate wall 30, which rotates, from outer race 53, which is stationary.

Bearings 42, 48, and 52 can be preloaded by pump frame 58 and support member 60. Pump frame 58 can axially overlap an axial end face of bearing 52. Frame member 72 of support member 60 can axially overlap an axial end face of bearing 48. An axial inward force is applied to axial end faces of bearings 52 and 48 as bearings 52, 42, and 48 are compressed between pump frame 58 and frame member 72 when support member 60 is secured to connect frame members 58, 72 together. An axial inward force in the direction AD2 is applied to the radially extending axial end face of bearing 52, and specifically, to the outer axial end face of outer race 53. An axial inward force in the direction AD1 is applied to the radially extending axial end face of bearing 48, and specifically, to the outer axial end face of inner race 50. The axial forces preload bearings 42, 48, and 52 to remove play from bearings 42, 48, and 52 during operation of drive system 10. Wave spring washers can be used to reduce bearing noise. In some embodiments, a first wave spring washer 56 can be disposed between pump frame 58 and the axial end face of outer race 53 of bearing 52 at output end 24. A second wave spring washer 57 can be disposed between a portion of axle 23 and an axial end face of outer race 44 of bearing 42. Alternatively, or additionally, a wave spring washer can be disposed between a portion of axle 23 and an axial end face of inner race 50 of bearing 48.

The bearing arrangement of drive system 10 provides significant advantages. Bearings 52 and 48 react to pump reaction loads generated during pumping. Bearings 52, 48 facilitate a direct drive configuration of drive system 10. Bearings 52 and 48 stabilize rotor 22 to facilitate the direct drive connection to fluid displacer 16. The pump reaction forces experienced at output end 24 and input end 26 by bearings 52, 48 are transmitted to the portion of support frame 18 connected to a stand or otherwise supporting drive system 10 on a support surface. In the example shown, the pump reaction forces are transmitted to base plate 70 via pump frame 58, frame member 72, and connecting members 68, balancing the forces across support frame 18. Base plate 70 reacts the forces, such as to a stand connected to mounts 71, and the forces are thereby transmitted away from motor 12. All pump and motor forces are reacted through base plate 70, which can be integrally formed with or directly connected to pump frame 58 and is mechanically coupled to motor axle 23 via frame member 72. The connection balances motor 12, providing longer life, less wear, less downtime, more efficient operation, and cost savings. Bearing 42 further aligns rotor 22 on pump axis A. Bearing 42 minimizes the unsupported span of rotor 22, aligning rotor 22 and preventing undesired contact between rotor 22 and stator 20. Bearing 42 thereby increases the operational life of motor 12.

Support frame 18 mechanically supports electric motor 12 at output end 24 and at least partially houses fluid displacer 16. Support frame 18 can be mechanically coupled to both rotor 22 and stator 20. Support frame 18 can be mechanically coupled to rotor 22 at output end 24 and mechanically coupled to axle 23 at electrical input end 26. As such, support frame 18 can extend fully around motor 12 and be coupled to axially opposite ends of motor 12 to support motor 12. Axle 23 is mechanically coupled to support frame 18 to fix stator 20 relative to support frame 18. Axle 23 is fixed with respect to support frame 18 such that stator 20, which is fixed to axle 23, does not rotate relative to support frame 18 or motor rotational axis A.

Support member 60 can extend around an exterior of rotor 22 from pump frame 58 to axle 23 to connect pump frame 58 to axle 23 such that stator 20, via support member 60, is fixed relative to support frame 18. Support member 60 can be removably fastened to axle 23. Support member 60 fixes axle 23 to pump frame 58 to prevent relative movement between stator 20 and support frame 18. Neither axle 23 nor stator 20 are fixed to support frame 18 at output end 24. Instead, a portion of rotor 22 is disposed axially between and separates axle 23 and stator 20 from support frame 18. As such, motor 12 is dynamically supported by support frame 18 at the output end 24 and statically supported by support frame 18 at the input end 26.

Support member 60 can extend from a location radially inward of an exterior of cylindrical body 28 of rotor 22 to a location radially outward of cylindrical body 28. Support member 60 can extend circumferentially around rotor 22 with sufficient radial spacing therefrom to allow unobstructed rotation of rotor 22 inside of support member 60. In the example shown, support frame 18 does not completely enclose rotor 22. It is understood that not all examples are so limited. In the example shown, no parts exist between support frame 18 and the exterior of rotor 22. Thus, support frame 18 allows airflow through itself and over rotor 22.

Support member 60 includes one or more connecting members 68, base plate 70, and frame member 72. It is understood that each connecting member 68 can be formed by a single component or multiple components fixed together. Each connecting member 68 can also be referred to as a connector. Base plate 70 can also be referred to as a connector. Connecting members 68 and base plate 70 extend across cylindrical body 28 and are spaced therefrom. Frame member 72 is disposed at electrical input end 26 and coupled to axle 23. Frame member 72 can also be referred to as a frame end. Frame member 72 extends radially with respect to motor axis A and is mechanically coupled to connecting members 68 and base plate 70. Connecting members 68 and base plate 70 can extend axially outward from pump frame 58 in axial direction AD2. Connecting members 68, 70 are spaced radially from cylindrical body 28. Connecting members 68 of support member 60 can extend parallel to motor axis A or can be angled such that an end of the connecting member 68 at output end 24 can be circumferentially offset about axis A from an end of the connecting member at electrical input end 26.

Frame member 72 of support member 60 can extend substantially parallel to second wall 32 of rotor 22 and can be axially spaced therefrom. Frame member 72 can be disposed substantially parallel to pump frame 58. Frame member 72 extends from axle 23 to a location radially outward of cylindrical body 28 where frame member 72 joins with connecting members 68 and base plate 70. Frame member 72 is fixed to axle 23.

Support member 60 connects to pump frame 58 at output end 24. Support member 60 can connect to pump frame 58 at one or more locations radially outward of cylindrical body 28 or at one or more locations radially inward of cylindrical body 28 and then extend radially to a location radially outward of cylindrical body 28. Support member 60 fixes an axial location of stator 20 with respect to rotor 22 and pump axis PA and axially secures components of electric motor 12 together along the motor axis A. Support member 60 can be a unitary body or can include multiple components fastened together and capable of connecting stator 20 to pump frame 58 to maintain stator 20 in a fixed axial location relative to rotor 22 and pump frame 58 on axis A.

In a non-limiting embodiment, connecting members 68 can be tie rods, which can be circumferentially spaced around a top portion of motor 12. The tie rods can be removably mounted to one or both of pump frame 58 and frame member 72. Base plate 70 can be a substantially solid base plate or bracket disposed under a bottom portion of motor 12. Base plate 70 can have a width substantially equal to a width of pump housing portion 62. In some embodiments, base plate 70 can have a width substantially equal to or greater than a diameter of cylindrical body 28 of rotor 22.

Frame member 72 can include hub 74. Frame member 72 can be removably coupled to axle 23. For example, frame member 72 can be slidingly engaged with axle 23. In some examples, frame member 72 can be fixed to axle 23. For example, hub 74 of frame member 72 can be bolted to axle 23 or secured to axle 23 with a retaining nut (not shown). Connecting members 68 and base plate 70 can be secured to frame member 72 and can fix hub 74 to axle 23.

In addition to providing mechanical support to motor 12, support member 60 can conduct heat away from motor 12 during operation. Axle 23 extends through rotor 22 and axially outward from rotor at electrical input end 26 and can project in axial direction AD2 outward of bearing 48. The portion extending axially beyond bearing 48 can connect with support member 60 and provide a route for conductive heat transfer from stator 20 to support member 60 and away from electric motor 12. More specifically, frame member 72 is fixed to axle and in a direct heat exchange relationship therewith. As discussed in more detail below, frame member 72 is configured to conduct heat both from motor 12 and control panel 13, which are the main heat generating components of drive system 10.

Both axle 23 and support member 60 can be formed of a thermally conductive material (e.g., metal). Axle 23 can be placed in direct contact with support member 60 (e.g., with frame member 72) to provide a direct conductive heat path to route heat away from motor 12. As illustrated in FIG. 4, axle 23 radially overlaps stator 20 along a full axial length of stator 20. Axle 23 is capable of drawing heat from stator 20 and conducting heat toward electrical input end 26 and axially outward of stator 20. Axle 23 transfers heat to frame member 72 via conduction at locations where frame member 72 is in contact with axle 23. As such, the conductive pathway for heat transfer from stator 20 extends through axle 23 to frame member 72. In some embodiments, frame member 72 can be in fixed contact with both an axially extending surface of axle 23 and a radially extending end face of axle 23. For example, a portion of frame member 72, such as a lip extending from hub 74, can extend radially over an end of axle 23 to increase the surface area of the direct contact and transfer heat away from axle 23 and away from electric motor 12. A shape and surface area of frame member 72 can be selected to facilitate heat transfer away from electric motor 12.

Controller 15 can receive a signal from a position sensor 102 (shown in FIGS. 4 and 4A). Position sensor 102 can be included in any of the disclosed drive systems. Position sensor 102 is configured to generate positional information regarding a component of spray system 10. For example, position sensor 102 can be configured to sense a rotational position of rotor 22, a position of fluid displacer 16, a position of the rotating component of drive 14, etc. In the example shown in FIGS. 4 and 4A the sensor 102 is configured as a motor sensor configured to measure, directly or indirectly, a rotational position of rotor 22. Position sensor 102 is configured to sense the rotational position of rotor 22. For example, motor sensor 102 can be configured as an encoder configured to generate data regarding the actual position of rotor 22 of motor 12. Position sensor 102 can determine the orientation of rotor 22 so that the rotational position of rotor 22 is always known, which can be useful for reversing rotor 22 and for determining the actual position of fluid displacer 16 within a pump stroke. The position of fluid displacer 16 can be determined based on information output by position sensor 102. For example, position sensor 102 can be a multi-axis magnetic sensor with multiple magnets on rotor 22 in different orientations and a magnetic field sensor on stator 20 that measures the changes to the magnetic fields to determine the instantaneous rotational position of rotor 22. While position sensor 102 is described as associated with sensing the rotational position of rotor 22, it is understood that position sensor 102 can be associated with fluid displacer 16 to directly sense a linear position of fluid displacer 16.

Controller 15 can receive a signal from fluid sensor 120 (shown in FIG. 4). Fluid sensor 120 can be included in any of the disclosed drive systems. Fluid sensor 120 is configured to generate information regarding a parameter output by pump 19. Fluid sensor 120 can be configured to generate information regarding the sensed parameter, such as pressure, flow, etc. Fluid sensor 120 can be a pressure transducer which measures fluid pressure output by pump 19. Fluid sensor 120 can be, for example, a spring gauge sensor. Fluid sensor 120 can be a flow sensor configured to generate information regarding a flow of the fluid output by pump 19. Fluid sensor 120 is disposed downstream of pump outlet 101.

FIG. 5 shows a front isometric view of one embodiment of pump frame 58 with base plate 70. Pump frame 58 and base plate 70 can be integrally formed, such as by, for example, casting as a unitary component, or can be formed from multiple components mechanically fixed together. For example, pump frame 58 and base plate 70 can be removably connected together, such as by bolts or other fasteners. Pump frame 58 can include drive link housing 61, pump housing portion 62, inner frame body 63a, outer frame body 63b, mid-frame body 63c, projections 64a with distal ends disposed radially outward of electric motor 12, support ribs 65, handle attachment 66, and hub 67. Pump frame 58 provides mechanical support and housing for pump 19.

Pump frame 58 provides mechanical support for motor 22. Pump frame 58 can extend radially outward from bearing 52. Bearing 52 can be received in hub 67. Rotor 22 can be received through an opening in inner frame body 63a. Outer frame body 63b is positioned radially outward of inner frame body relative to motor axis A. Mid-frame body 63c is positioned between inner frame body 63a and outer frame body 63b. Ribs 65 can extend between inner frame body 63a and mid-frame body 63c, between inner frame body 63a and outer frame body 63b, and between mid-frame body 63c and outer frame body 63b. Ribs 65 can be used to reduce a weight of pump frame 58 while providing structural support. In some embodiments, a plurality of ribs 65 can extend between hub 67 and outer frame body 63b. Ribs 65 can support load from bearing 52 and can reduce weight of pump frame 58. Ribs 65 can be spaced substantially circumferentially around a portion of hub 67. Ribs 65 can vary in length depending on a shape of outer frame body 63b or positioning relative to bearing 52, inner frame body 63a, or mid-frame body 63c. As illustrated in FIG. 5, outer frame body 63b can have a different shape than bearing 52b, which is cylindrical. As such, a perimeter of outer frame body 63 is not evenly spaced from a perimeter of bearing 52 or hub 67 and ribs 65 connecting hub 67 to outer frame body 63b vary in length accordingly. A size and shape of outer frame body 63b and quantity, thickness, and positioning of ribs 65 can be selected to support bearing 52 and electric motor 12 while reducing weight of pump frame 58. Projections 64a can be substantially solid triangular projections extending from hub 67. Projections 64a can form attachment points for members 68 to secure frame member 72 to pump frame 58.

Drive link housing 61 can be positioned in the opening in inner frame body 63a. As illustrated in the example in FIG. 5, drive link housing 61 is a cylindrical body positioned below the opening and above pump housing portion 62. An opening of drive link housing 61 is orthogonal to the opening through inner frame body 61. Drive link housing 61 limits movement of drive link 82 to up and down motion along pump axis PA.

Pump housing portion 62 of pump frame 58 at least partially houses fluid displacer 16 and supports displacement pump 19. Pump 19 is disposed at output end 24 on pump axis PA orthogonal to motor axis A and axially aligned with drive mechanism 14 along axis A. Pump housing portion 62 of pump frame 58 can extend in an axial direction AD1 outward of drive mechanism 14 to house fluid displacer 16. As illustrated in the example in FIG. 5, pump housing portion 62 is formed by U-shaped walls opening to a front end of pump frame 58 away from motor 12 in axial direction AD1. A portion of pump 19 is disposed in the chamber of pump housing portion 62 during operation.

Pump 19 is configured to draw fluid into pump through pump inlet 99 and to output fluid through pump outlet 101. The pump body 19a defines pump chamber 88 through which the fluid is pumped. The fluid displacer 16 divides the pump chamber 88 into an upstream chamber 88a and a downstream chamber 88b. In the example shown, the piston head 103 of the piston forming fluid displacer 16 divides the pump chamber 88 into the upstream chamber 88a and downstream chamber 88b.

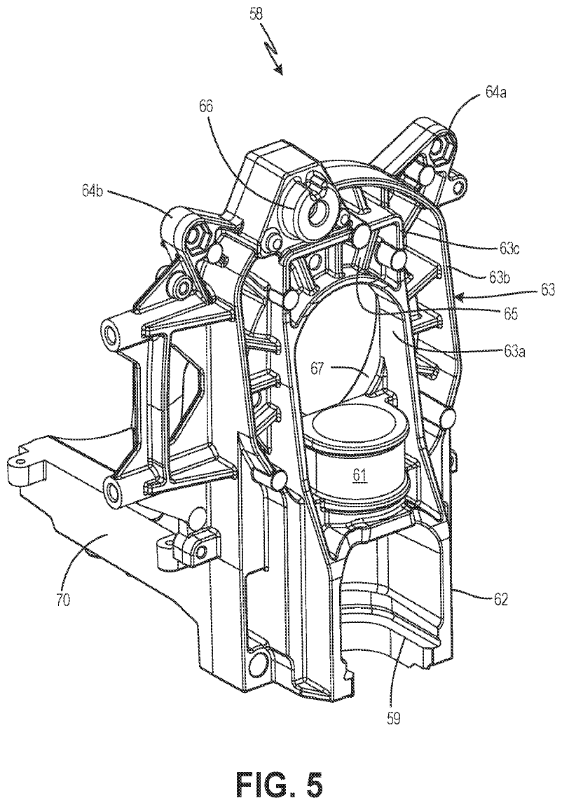

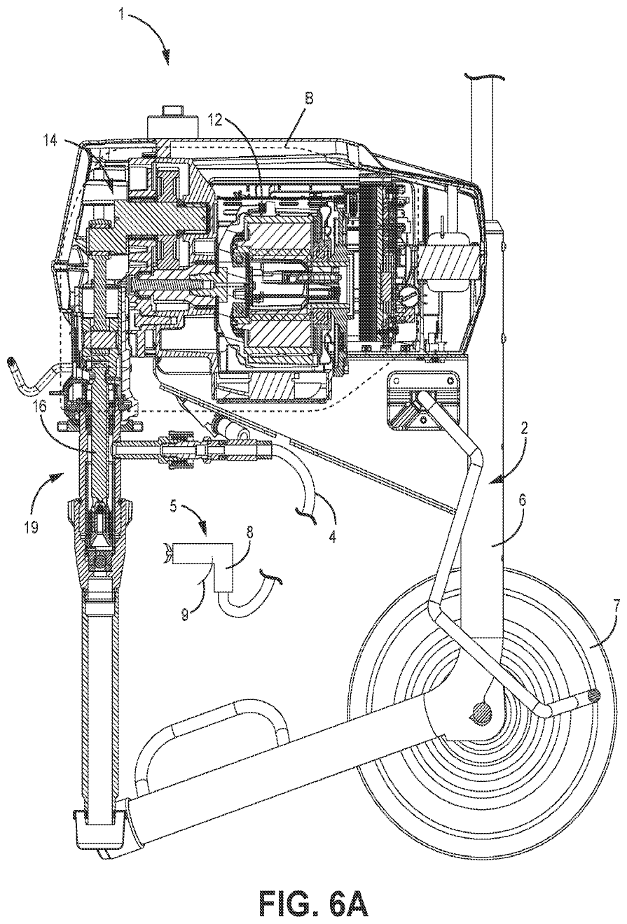

FIGS. 6A-7 show a different embodiment than that of the previous figures. However, the embodiments are similar to each other and any detail referenced in connection with one embodiment either is present in the other embodiment or can be present in the other embodiment. As such, all aspects between embodiments can be assumed to be the same unless shown and/or described to be clearly different such that the descriptions and drawings for one embodiment are applicable to the other embodiment. Various common aspects are not repeated between embodiments for brevity.

Components having the same reference numbers can be the same such that descriptions and/or drawings for one component can be imputed to another component, having the same reference number, of a different embodiment. Likewise, components having the same name can be the same such that descriptions and/or drawings for one component can be imputed to another component, having the same name, of a different embodiment.

FIG. 6A shows a cross-sectional view of spray system 1. Spray system 1 can be similar to the previous embodiment except that the drive mechanism 14 is different.

FIG. 6B is an enlarged view of detail B in FIG. 6B. In this embodiment, the rotor 22 rotates circumferentially around the stator 20 and is disposed radially outwards of the stator 20. The motor 12 is the same as in previous embodiments except for how the rotor 22 is connected to drive mechanism 14 to power drive mechanism 14. Specifically, in the prior examples, an eccentric was attached directly to the housing of the rotor 22 such that the rotor 22 and eccentric rotated in a 1:1 relationship. In the example shown in FIGS. 6A-7, a pinion cap 39 is attached to the rotor 22 and rotates with the rotor 22. More specifically, a stud 33 is integral (e.g., contiguous material) with the rotor housing or is attached to the rotor housing. The pinion cap 39 is mounted on the stud 33. The pinion cap 39 rotates with the rotor 22 about axis A. The pinion cap 39 is fixed to the stud 33 in part by fastener 84. Fastener 84 can be a bolt which extends within the pinion cap 39 from the second end of the pinion cap 39 to the first end of the pinion cap 39.

In this embodiment, the stud 33 includes external threading which interfaces with internal threading of the pinion cap 39. The orientation of the relative threading can be in a first direction (e.g., clockwise or counterclockwise). Stud 33 also includes internal threading within a receiver of the stud 33. The internal threading of the stud 33 interfaces with external threading on the end of the fastener 84. The orientation of the relative threading between the stud 33 and fastener 84 can be in a second direction opposite of the first direction. Having threading in both directions ensures that the connection between the stud 33 and the pinion cap 39 is maintained even if the motor 12 reverses its direction of rotation. Fastener 84 can be a bolt.

In alternative embodiments, the pinion cap 39 is keyed (e.g., hexed) to the stud 33 instead of a threaded connection to prevent relative rotation.

The pinion cap 39 is supported by first bearing 77 and second bearing 79. Both bearings can be a needle type bearing. The first bearing 77 is supported by pump frame 18. The second bearing 79 is supported by retainer plate 47. As such, a first end of the pinion cap 39 engages first bearing 77 while a second and of the pinion cap 39 engages second bearing 79 and a section of the pinion cap 39 between the first and the second ends contains gear teeth. In this way, the pinion cap 39 includes an exterior gear teeth section. The exterior gear teeth section engages teeth of gear 69. Gear 69 rotates with pinion cap 39 however at a slower rate due to the gear reduction between the pinion cap 39 and the gear 69. Bolts can fasten retainer plate 47 to the pump frame 18. To capture the pinion cap 39 therebetween.

The gear 69 is supported by eccentric 81. Specifically, the gear 69 is fixed to the eccentric 81 so that the eccentric 81 rotates 1:1 with the gear 69. The eccentric 81 is supported by third bearing 85 and forth bearing 87 (which can also be needle type) which allows the eccentric 81 to rotate. The third bearing 85 is supported by pump frame 18 while the fourth bearing 87 is supported by retainer plate 47. The eccentric 81 includes eccentric driver 78 which rotates offset from the center of rotation of the rest of the eccentric 81. Follower 86 and bearing member 89 are mounted on the eccentric driver 78 to follow a circular pattern that moves drive member 80 up and down which reciprocates the fluid displacer 16 of pump 19 for pumping.

FIG. 7 shows an exploded view of various components of the embodiment of FIGS. 6A and 6B. As shown, the pinion cap 39 includes a first end which is covered by first bearing 77, a second end which is covered by second bearing 79, and a gear teeth section between the first and second ends. This gear teeth section interfaces with teeth of gear 69. In the example shown, the pinion cap 39 is connected to the gear 69 such that gear 69 rotates less than one full rotation for each full rotation of rotor 22. As such, rotor 22 is configured to complete multiple full rotations for a single pump cycle of the pump 19.

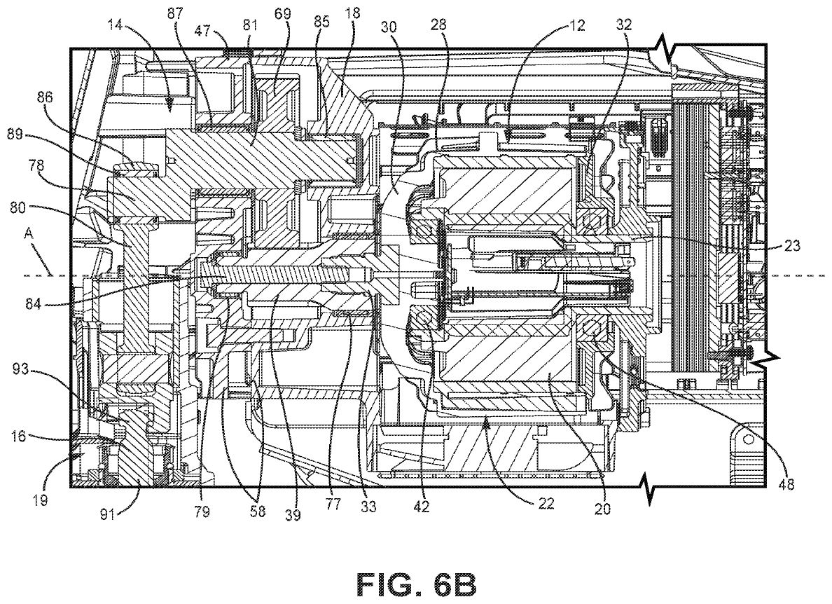

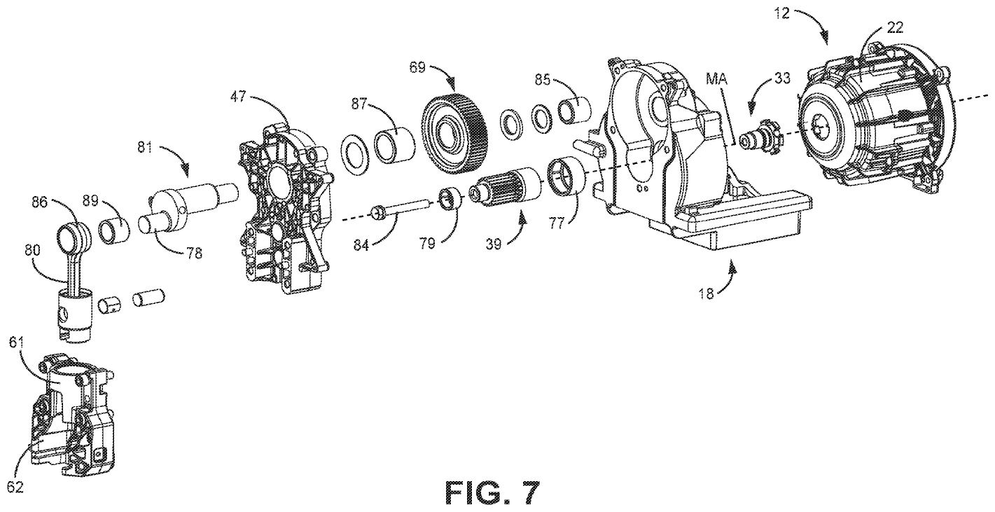

FIG. 8 is an isometric view of a drive system 10. FIG. 9 is a cross-sectional view of the drive system shown in FIG. 8. FIGS. 8 and 9 shows a different embodiment as that of FIGS. 6A-7. All previous teachings reference numbers apply to the embodiment of FIGS. 8 and 9 as they do to the previous embodiments. This embodiment also includes a pinion cap 39. However, the pinion cap 39 is mounted on the stud 33 without the use of a bolt. The pinion cap 39 can be threaded or welded to the stud 33, among other options.

Of particular note concerning the embodiments of FIGS. 6A-9 is that the pinion cap 39 replaces a conventional pinion. An outer rotor, such as rotor 22, cannot use a conventional pinion. In conventional drive motors, a rotor rotates within the stator, instead of the rotor 22 rotating radially around the stator 20 as in the present embodiments. Moreover, in the conventional drive motors, a pinion shaft extends through the motor, including the rotor, such as the pinion shaft radially overlaps with the electromagnetics of the motor. In the present embodiments, no shaft extends entirely axially through the motor, whether part of the pinion or not. In this case, a pinion cap 39 is mounted onto an outer rotor, the pinion cap 39 including the gear teeth section having teeth for interfacing with the gear 69. The pinion cap 39 does not extend through the motor. Rather, the pinion cap 39 is only connected with an outer housing of the rotor 22. The pinion cap 39 is supported by dual bearings on opposite ends, with a third section (e.g., gear teeth section) being axially between the opposite ends supported by the bearings. In the example shown, the rotor 22 includes an open end that faces away from the pump.

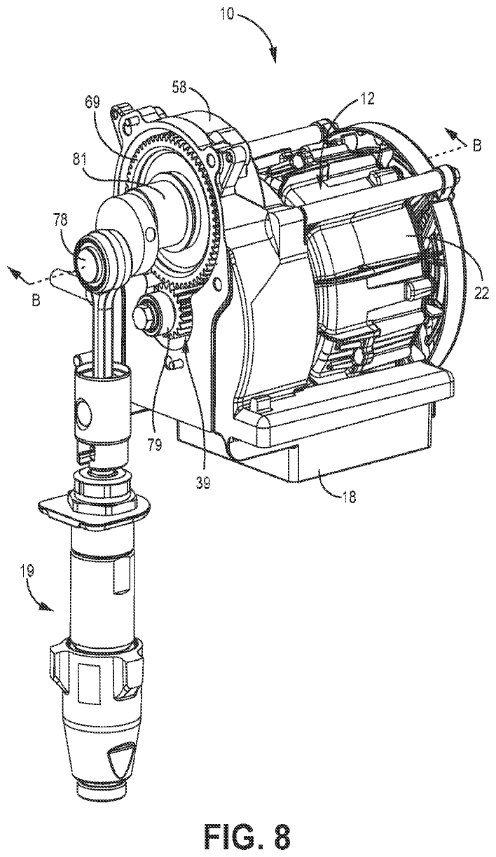

FIG. 10 is a schematic view of a pump 19. The pump 19 can be the pump of the embodiment shown previously (e.g., pump 19) or could be the pump of a different system. Shaft 91 can be connected to a drive mechanism (e.g., drive mechanism 14) which is operated by an electric motor (e.g., motor 12). While schematically a piston pump is shown, the fluid displacer 16 can instead be a diaphragm or other type of reciprocating pump. In other examples the fluid displacer 16 can be configured to rotate on an axis to pump the fluid without reciprocation.

In the example shown, the fluid displacer 16 reciprocates to increase and decrease the available volume in a pump chamber 88. The fluid displacer 16 divides the pump chamber 88 into an upstream chamber 88a and a downstream chamber 88b. During a suction stroke, the fluid displacer 16 moves away from the inlet check valve 96 to increase the volume of the pump chamber 88, drawing fluid through the inlet check valve 96 and into the pump chamber 88. Typically during the suction stroke (in the upward axial direction), the outlet check valve 95 is closed while the inlet check valve 96 is open. During the pressure stroke (in the downward axial direction), the fluid displacer 16 moves toward the inlet check valve 96 to decrease the volume of the pump chamber 88 to force the fluid out of the pump outlet 101. In this particular case, the fluid can flow through the fluid displacer 16, specifically through the outlet check valve 95, as this is a double acting pump in which the outlet check valve 95 is mounted on the fluid displacer 16 and fluid is output through pump outlet 101 on both the suction stoke and the pressure stroke. Each of the suction stroke and the pressure stroke can be referred to individually as a pump stroke. Alternatively, the pump 19 could be a single acting pump in which the outlet check valve 95 is not mounted on the fluid displacer 16, and in such case the outlet check valve 95 may be mounted on or at the fluid outlet 101 or other component downstream of the fluid chamber 88. Check valve 96 can also be referred to as an upstream check valve. Check valve 95 can also be referred to as a downstream check valve.

During the suction stroke, the fluid displacer 16 moves to increase a volume of the upstream chamber 88a and decrease a volume of the downstream chamber 88b. During the pressure stroke, the fluid displacer 16 moves to decrease a volume of the upstream chamber 88a and increase a volume of the downstream chamber 88b. As noted above, pump 19 can be configured as a double acting pump in which the pump 19 outputs fluid through the pump outlet 101 during both the suction stroke and the pressure stroke.

It is noted that suction strokes and pressure strokes may alternatively be referred to as upstrokes and downstrokes, respectively. It is noted that the pressure stroke can alternatively be referred to as a pumping stroke. It is noted that suction strokes and pressure strokes may alternatively be referred to as a first stroke and a second stroke of a pump cycle, with the motion of the fluid displacer 16 being in a first direction (e.g., first pump axial direction PAD1) during the first stroke and in a second direction (e.g., second pump axial direction PAD2) opposite the first direction in the second stroke. These terms may be used interchangeably herein.

As the rotor 22 of the electric motor 12 spins, the drive mechanism 14 converts the rotation into reciprocation of the fluid displacer 16. As such, the rotor 22 may spin in one rotational direction, such as clockwise or counterclockwise, over the course of a plurality of continuous pump cycles in which the fluid displacer 16 alternates between suction strokes and pressure strokes without the rotor 22 stopping. While the rotor 22 does not stop, the flow rate of the output of the pump 19 increases and decreases throughout the cycles. In particular, the flow rate and/or pressure output decrease on changeover of the fluid displacer 16. Changeover refers to the reversal of the direction of reciprocation of the fluid displacer 16. For example, the fluid displacer 16 experiences changeover when transitioning from the suction stroke to the pressure stroke, and once more when transitioning from the pressure stroke back to the suction stroke.

During changeover, the check valves 95, 96 also alternate from permitting fluid flow through the valve when the valve is open and blocking retrograde flow when the valve is closed. For example, on the suction stroke, the outlet check valve 95 is closed while the inlet check valve 96 is open. On the pressure stroke, the inlet check valve 96 is closed while the outlet check valve 95 is open. Pressure losses can be experienced during the momentary change between opening and closing of these valves, which may be due to a small amount of retrograde fluid flow before the valve is able to close. During changeover, check valves 95, 96 delaying in seating in the closed position can lead to pressure differentials between the fluid pressure in the upstream chamber 88a and the fluid pressure in the downstream chamber 88b. The pressure differential acts on fluid displacer 16 and can cause fluid displacer 16 to accelerate. For example, on changeover from the suction stroke to the pressure stroke, the pressure in upstream chamber 88a may drop prior to inlet check valve 96 reaching the closed state. Such drop in pressure can be due to retrograde flow and without a sealed upstream chamber 88a pressure is not built. Once inlet check valve 96 seats, pressure again builds in upstream chamber 88a as the volume of upstream chamber 88a shrinks and the fluid is forced through outlet check valve 95. During the suction stroke, upstream chamber 88a has very low pressure, possibly even a partial vacuum. On changeover from suction stroke to pressure stroke, the pressure in upstream chamber 88a should start to increase, at least back to atmospheric pressure. The pressure in downstream chamber 88b will start to decrease on changeover as the movement of fluid displacer 16 causes the volume in chamber 88b to increase and the volume in chamber 88a to decrease.

During pumping, controller 15 is configured to cause the motor 12 to accelerate, decelerate, or maintain speed based on the sensed position of the fluid displacer 16. Controller 15 is pre-programmed to control acceleration and/or deceleration and/or maintain speed based on sensed position, such that controller 15 actively controls power provision to the motor 12 rather than responsively based on sensed pressure or flow. Such a configuration provides for more efficient operation of motor 12 and pumping by pump 19 as compared to a configuration responsive to parameters of the fluid output by pump 19.

To compensate for the drop in pressure, and to minimize retrograde flow, during pumping, some examples in the present disclosure concern controlling the electric motor 12 based on the position of the fluid displacer 16. The controller 15 can control the electric motor 12 to move faster in association certain portions of the pump stroke and slower when the fluid displacer 16 is in other portions of the pump stroke. The controller 15 actively controls power to the electric motor 12 based on the position of the fluid displacer 16, such as based on position data from the sensor 102, sensing the position of fluid displacer 16 directly or sensing the position of rotor 22 to determine the position of fluid displacer 16. Controller 15 is not varying the power to the motor 12 to accelerate, decelerate, drive displacement of the rotor 22 based on fluid parameters (e.g., pressure or flow) of the fluid output by pump 19.

In some examples, controller 15 can control the electric motor 12 to move faster in association with changeover and to move slower when the fluid displacer 16 is not near changeover. Accordingly, the rotor 22 spins faster when the fluid displacer 16 is in or near changeover while the rotor 22 spins slower when the fluid displacer 16 is not in or near changeover. As such, the fluid displacer 16 gets through the less efficient parts of the stroke faster and also increases output through faster movement, with the aim of having consistent flow and pressure output throughout the entirety of the pump cycle, including during changeover.

In some examples, controller 15 can control the electric motor 12 to move slower in association with changeover and to move faster when the fluid displacer 16 is not near changeover. Accordingly, the rotor 22 spins slower when the fluid displacer 16 is in or near changeover while the rotor 22 spins faster when the fluid displacer 16 is not in or near changeover.

In some examples, controller 15 is configured to cause the rotor 22 of the motor 12 to coast with the fluid displacer 16 at or near changeover. Controller 15 can reduce the power level provided to motor 12 to cause rotor 22 to coast. In some examples, controller 15 can stop providing power to the motor 12 to cause the rotor 22 to coast. Controller 15 causing the motor 12 to coast reduces power draw as the fluid displacer 16 moves through changeover.

The schematic view of FIG. 10 separates the stroke into a first end part 104, a middle part 106, and a second end part 108. The first end part 104 may be associated with changeover and the second end part 108 may be associated with changeover, whereas the middle part 106 is not associated with changeover. In the example shown, the first end part 104 is associated with changeover from the suction stroke to the pressure stroke and the second end part 108 is associated with changeover from the pressure stroke to the suction stroke. In the example shown, the first end part 104 can also be referred to as an upper part of the stroke and the second end part 108 can also be referred to as a lower part of the stroke.

The length of the middle part 106 is longer than each of the first end part 104 and the second end part 108 in the example shown. In this particular embodiment, the length of the middle part 106 is longer than the first end part 104 and the second end part 108 combined for a single stroke. In various embodiments, the length of the middle part 106 can be at least twice as long as the length of the first end part 104 and the second end part 108 combined.

In various embodiments, the electric motor 12 accelerates (from a speed in the middle portion 106) when the fluid displacer 16 is coming into changeover in the first end part 104 before the fluid displacer 16 reversing direction and then the electric motor 12 slows down after having reversed direction while in the first end part 104 to the speed for the middle portion 106. In various embodiments, the electric motor 12 accelerates (from its speed with the fluid displacer 16 in the middle portion 106) when the fluid displacer 16 is coming into changeover in the second end part 108 before the fluid displacer 16 reversing direction and then the electric motor 12 slows down after having reversed direction while the fluid displacer 16 is in the second end part 108 to the speed for the middle portion 106.

In various examples, the electric motor 12 maintains its speed from the middle portion 106 when coming into changeover in the first end part 104 but accelerates during and/or after the fluid displacer 16 reversing direction while in the first end part 104 and then motor 12 decelerates while fluid displacer 16 is in the first end part 104 to the speed for the middle portion 106. In various embodiments, the electric motor 12 maintains its speed from the middle portion 106 when coming into changeover in the second end part 108 but accelerates during and/or after the fluid displacer 16 reversing direction while in the second end part 108 and then motor 12 decelerates while the fluid displacer 16 is in the second end part 108 to the speed for the middle portion 106.

It is understood that the controller 15 controls the speed of the rotor 22 of the electric motor 12 to control movement of the fluid displacer 16. For example, power signals are provided to motor 12 such that rotor 22 accelerates (from a speed with fluid displacer 16 in the middle portion 106) when fluid displacer 16 is coming into changeover in the first end part 104 before fluid displacer 16 reverses direction and then the rotor 22 slows down after the fluid displacer 16 has reversed direction while in the first end part 104 to a rotational speed for the middle portion 106. In various embodiments, the rotor 22 accelerates (from its speed with fluid displacer 16 in the middle portion 106) when the fluid displacer 16 is coming into changeover in the second end part 108 before the fluid displacer 16 reverses direction and then the rotor 22 slows down after the fluid displacer 16 has reversed direction while in the second end part 108 to a rotational speed for the middle portion 106.

In some examples, power signals are provided to the motor 12 such that the rotor 22 maintains its speed from when the fluid displacer 16 is in the middle portion 106 when the fluid displacer 16 comes into changeover in the first end part 104 but the rotor 22 accelerates during and/or after reversing direction while in the first end part 104 and then the rotor 22 decelerates while in the first end part 104 to the speed for the middle portion 106. In various embodiments, the power signals are provided to the motor 12 such that the rotor 22 maintains its speed from when the fluid displacer 16 is in the middle portion 106 when the fluid displacer 16 is coming into changeover in the second end part 108 but the rotor 22 accelerates during and/or after the fluid displacer 16 reversing direction while in the second end part 108 and then the rotor 22 decelerates while the fluid displacer 16 is in the second end part 108 to the speed for the middle portion 106.

Sensor 102 is a position sensor associated with the fluid displacer 16 in the examples shown. Data generated by sensor 102 can be used to determine the position of the fluid displacer 16 along the stroke to know when the motor 12 should accelerate and decelerate. Sensor 102 is configured as a position sensor. For example, sensor 102 can be an encoder, Hall effect sensor, magnetic field sensor, or other type of sensor. Sensor 102 is configured to generate position information that can be used to determine a position of fluid displacer 16. For example, sensor 102 can be located to sense the location and/or movement of reciprocating component (e.g., fluid displacer 16) or may be located to sense location and/or movement of the rotating component, such as part of the rotor 22 or part of drive mechanism 14, for which the position of the fluid displacer 16 can be inferred.

The acceleration and deceleration of the fluid displacer 16 along the first end part 104, the middle part 106, and the second end part 108 is driven by a signal indicating (directly or indirectly) the position of the fluid displacer 16. In such a case, the decision to accelerate and decelerate may be made independent of sensed changes in the output parameters of the fluid (e.g., changes in flow, pressure, or other sensed parameter of the pumped fluid). The motor 12 is controlled based on preprogrammed instructions stored in controller 15. The controller 15 causes speed changes of the motor 12 based on the position of the fluid displacer 16 not based on the fluid parameters of the system 1. The decision to accelerate and decelerate can be made independent of sensed increases or decreases in the fluid pressure which may be fluctuating for a variety of reasons. Moreover, accelerating into the changeover, or during and/or immediately after the changeover, may eliminate the pressure fluctuations, such that the system must anticipate the positions in which the pressure fluctuations occur in order to change speed to avoid such pressure fluctuations instead of responding to the fluctuations after they begin. The speed may be managed by controller 15.

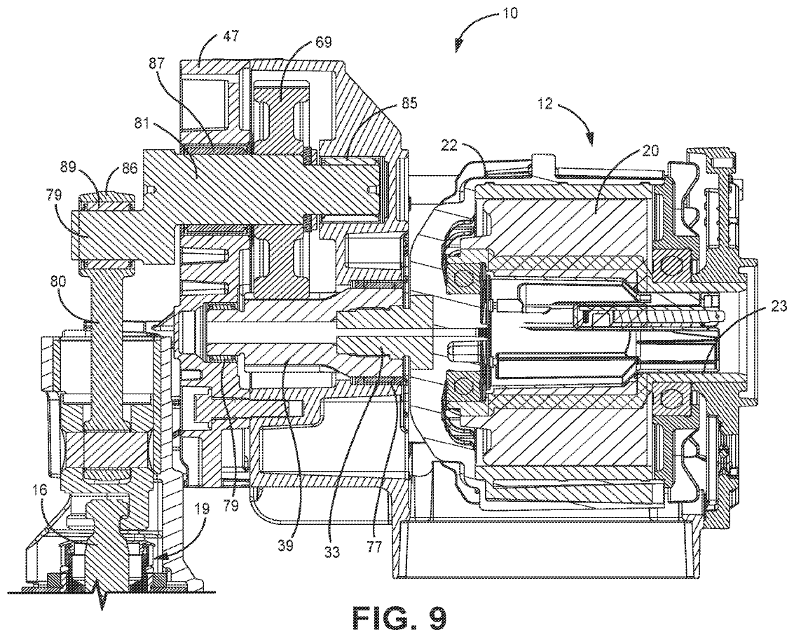

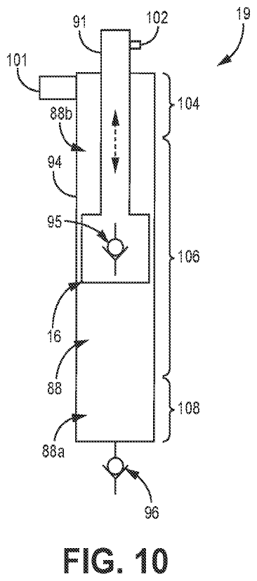

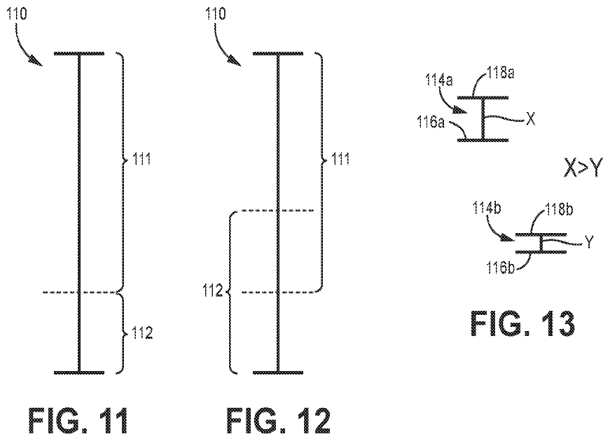

FIG. 11 is a schematic view of a pressure range 110 showing high-pressure range 111 and low-pressure range 112 as discrete pressure ranges. FIG. 12 is a schematic view of a pressure range 110 showing high-pressure range 111 and low-pressure range 112 as overlapping pressure ranges. FIG. 13 is a schematic view showing tolerance ranges 114a, 114b. The pressure range 110 may correspond with the range of input pressures that the controller 15 targets, such that the user selects a pressure along the range with an interface (e.g., user interface 17), such as with a dial, button input, touchscreen, lever, or other input interface. It is understood that user interface 17 can include an input interface for inputting the target pressure and the same or a different interface can be utilized for selecting an operating mode of the controller 15. The controller 15 then controls the power signals provided to the electric motor 12 to cause the pump to output fluid at the target pressure, based on a signal received from a pressure sensor (e.g., sensor 120) that measures the pressure of the fluid output from the pump.

The pressure range 110 includes a high-pressure range 111 and a low-pressure range 112. The user may input a pressure that is in the high pressure range 111 or the low-pressure range 112. The controller 15 changes its operation based on whether a pressure within the high-pressure range 111 is selected as the target pressure or a pressure within the low-pressure range 112 is selected as the target pressure. In some examples, the controller 15 operates in either a high-pressure mode associated with the high-pressure range 111 or a low-pressure mode associated with the low-pressure range 112 without the user needing to select a separate mode. In some other embodiments, regardless of the pressure range selected, the user may select a mode that increases or decreases the sensitivity of motor restart, which may switch the sensitivity of a tolerance range between that of 114a and 114b. In some examples, the controller 15 can vary the size of the tolerance range depending on the target pressure. For example, the size of tolerance range 114a can vary depending on the location of the target pressure within low-pressure range 112.

In one example of operating spray system 1, the user selects a target pressure (e.g., 1000 pounds per square inch (psi) (about 6.89 Megaspascal (MPa)). If the sensor 120 indicates that the output pressure of the pump 19 is above the target pressure the controller 15 can cause the motor 12 to stop but if the sensor 120 indicates that the output pressure of the pump is below the target pressure the controller 15 can cause the motor 12 to start, continue, or accelerate to cause pump 19 to output the fluid under pressure. However, if the motor 12 is stopped with the actual pressure right at the target pressure, and then the hose supplying the pressurized fluid to the spray gun relaxes slightly and/or the user lowers the spray gun then the pressure may decrease and such a decrease can cause the motor 12 to be restarted even though no spraying has occurred.

To avoid starting of the motor 12 when there is no spraying, a tolerance range is implemented such that a higher pressure than the target pressure is needed to stop the motor 12 but a lower pressure than the target pressure is needed to restart the motor 12. FIG. 13 illustrates use of such buffers. Tolerance range 114a that is utilized when operating the sprayer with relatively higher target pressures and/or in a high-pressure mode. Tolerance range 114b that is utilized when operating the sprayer with relatively lower target pressures and/or in a low-pressure mode. For example, the controller 15 can implement the tolerance range 114b when the target pressure is in the low-pressure range 112 and can implement tolerance range 114a when the target pressure is in the high-pressure range 111.

The tolerance range 114a includes a lower threshold 116a and an upper threshold 118a. The tolerance range 114a is formed by the pressure range between the lower threshold 116a and the upper threshold 118a. The tolerance range 114b includes a lower threshold 116b and an upper threshold 118b. The tolerance range 114b is formed by the pressure range between the lower threshold 116b and the upper threshold 118b. The tolerance range 114a is shown as pressures within a range of X pressure and the tolerance range 114b is shown as pressures within a range of Y pressure. X is greater than Y. As such, the range of pressures between lower threshold 116a and upper threshold 118a is greater than the range of pressures between lower threshold 116b and upper threshold 118b.

In the examples shown in FIGS. 11 and 12, the motor 12, when operating in the high-pressure range 111, may be operated until the pressure reaches an upper threshold 118a but then if a subsequent reading indicates that the pressure is below the upper threshold 118a the motor 12 is not restarted until the pressure falls below lower threshold 116a, the tolerance range indicative of a meaningful pressure drop representative of spraying. In the examples shown in FIGS. 11-13B, the motor 12, when operating in the low-pressure range 112, may be operated until the pressure reaches an upper threshold 118b but then if a subsequent reading indicates that the pressure is below the upper threshold 118b the motor 12 is not restarted until the pressure falls below lower threshold 116b, the tolerance range indicative of a meaningful pressure drop representative of spraying.

However, such tolerance ranges may be needed to change based on the pressure, where a larger tolerance range is needed for high pressures and a narrower tolerance range needed for lower pressures. FIG. 13 shows a narrower tolerance range 114b than the tolerance range 114a. With controller 15 controlling motor 12 based on tolerance range 114b, the motor 12 may be operated until the pressure reaches upper threshold 118b and then stopped, but if a subsequent reading indicates that the pressure is below the upper threshold 118b the motor 12 is not restarted until the pressure falls below lower threshold 116b, the tolerance range 114b indicative of a meaningful pressure drop representative of spraying. X represents the range of pressures within the tolerance range 114a and Y represents the range of pressures within the tolerance range 114b, with X being greater than Y.

In the example shown in FIG. 12, the pressure range 110 includes a high-pressure range 111 and a low-pressure range 112. The high-pressure range 111 overlaps the low-pressure range 112 such that a single pressure can be within the range of both the high-pressure range 111 and the low-pressure range 112. For example, the low-pressure range 112 can be from about 50 psi (about 0.35 MPa) to about 2000 psi (about 13.79 Mpa), though other pressure levels are possible. For example, the high-pressure range 111 can be from about 600 psi (about 4.14 Mpa) to about 3300 psi (about 22.75 Mpa), though other pressure levels are possible. In some examples, the high-pressure range 111 can span a greater amount of pressure between a lower boundary of the high-pressure range 111 and an upper boundary of the high-pressure range 111 than the low-pressure range 112 spans between a lower boundary of the low-pressure range 112 and an upper boundary of the low-pressure range 112. With high-pressure range 111 and low-pressure range 112 overlapping, the upper boundary of the low-pressure range 112 can be intermediate the upper and lower boundaries of the high-pressure range 111.

In the example shown, the controller 15 can be configured to control operation of the motor 12 and select a tolerance range (e.g., tolerance range 114a or tolerance range 114b) based on an operating mode of the controller 15. The controller 15 can be placed in a high-pressure mode in which the controller 15 controls operation of the motor 12 based on the high-pressure range 111 and tolerance range 114a. The controller 15 can be placed in a low-pressure mode in which the controller 15 controls operation of the motor 12 based on the low-pressure range 112 and tolerance range 114b.

The user can select an operating mode of the controller 15, such as via a user interface (e.g., user interface 17). The operating mode can set the tolerance range for the controller 15 stopping and starting rotation of the rotor 22. The tolerance ranges 114a, 114b set pressure threshold levels relative to the target pressure for the controller 15 to start or stop operation of the electric motor 12.

The user may input a pressure that is in the high pressure range 111 or the low-pressure range 112. The controller 15 can be configured to automatically default to one or the other of the low-pressure mode and the high-pressure mode in instances in which the target pressure is a pressure within the overlap range between the high-pressure range 111 and the low-pressure range 112. In some examples, the controller 15 can default to utilizing the tolerance range 114b of the low-pressure range 112 for such target pressures to provide more responsive spraying. In some examples, the controller 15 can default to utilizing the tolerance range 114a of the high-pressure range 111 for such target pressures to prevent motor starts and stops caused by pressure fluctuations in the system that are not due to spraying. The controller 15 changes its operation based on whether the controller 15 is operating in the low-pressure mode or the high-pressure mode.

Reference is made to the tolerance range 114a tolerance range 114b. Such tolerance ranges 114a, 114b are representative of the spatial discrepancy between the relatively smaller tolerance range 114b utilized for the target pressures in the low-pressure range 112 and the relatively larger tolerance range 114a utilized for target pressures in the high-pressure range 111.

The tolerance range 114a includes a lower threshold 116a and an upper threshold 118a. The tolerance range 114a is formed by the pressure range between the lower threshold 116a and the upper threshold 118a. The lower threshold 116a is a pressure value less than the target pressure and the upper threshold 118a is a pressure value greater than the target pressure.

The tolerance range 114b includes a lower threshold 116b and an upper threshold 118b. The tolerance range 114b is formed by the pressure range between the lower threshold 116b and the upper threshold 118b. The lower threshold 116b is a pressure value less than the target pressure and the upper threshold 118b is a pressure value greater than the target pressure.

The tolerance range 114a is shown as pressures within a range of X pressure and the tolerance range 114b is shown as pressures within a range of Y pressure. X is greater than Y such that tolerance range 114a spans a greater range of pressures than tolerance range 114b. As such, the range of pressures between lower threshold 116a and upper threshold 118a is greater than the range of pressures between lower threshold 116b and upper threshold 118b.

In the example shown in FIG. 12, tolerance range 114a is associated with the controller 15 operating in the high-pressure mode and tolerance range 114b is associated with the controller 15 operating in the low-pressure mode. With controller 15 operating in the high-pressure mode, the tolerance range 114a is used such that relatively greater pressure variations are needed to start and stop the motor 12 than when controller 15 is operating in the low-pressure mode. When controller 15 is operating in the low-pressure mode, the tolerance range 114b is used such that relatively less pressure change is needed to start and stop the motor 12 than when operating in the high-pressure mode. Typically when operating in a low-pressure range 112, smaller pressure drop is experienced such that the system must be more sensitive to the smaller pressure drop to responsively restart the motor 12. Typically when operating in the high-pressure range 111, large pressure drops are experienced even when not spraying such that excessive motor restarts could be experienced even when not spraying.

In the example shown in FIG. 12, the low-pressure range 112 overlaps with the high-pressure range 111 such that a single target pressure can fall within either or both of the high-pressure range 111 and the low-pressure range 112. The user selecting the operating mode for the controller 15 instructs the controller 15 which tolerance range should be utilized for the target pressure. Controller 15 being operable in a high-pressure mode and a low-pressure mode provides significant advantages. The controller 15 implements a tolerance range 114a when operating in the high-pressure mode and implements a different tolerance range 114b when operating in the low-pressure mode. The high-pressure range 111 and low-pressure range 112 can overlap and putting the controller 15 in either the high-pressure mode or the low-pressure mode affects the responsiveness of the system when starting and stopping spraying. The user can place the controller 15 in the desired operating mode to provide desired reactiveness depending on the configuration of the spray system, the type of fluid being sprayed, etc. For example, the user may desire a more responsive system when spraying more expensive fluids to prevent waste due to spitting or sputtering at the start of spraying, in which case the user can select the low-pressure mode.

If the target pressure falls into only a single pressure range (e.g., the target pressure is lower than the low end of the high-pressure range 111 or higher than the high end of the low-pressure range) then the controller 15 can default to utilizing the tolerance range associated with the pressure range of that target pressure. For example, if the user selects a target pressure greater than the high pressure of the low-pressure range 112, then the controller 15 will default to operating in the high-pressure mode regardless of the user selected mode. In some examples, the controller 15 can cause the user interface 17 to output a notification to the user regarding the pressure mode that the controller 15 is operating in, such as to inform the user that the pressure mode selected by the user is unavailable for the target pressure. It is understood that in some examples the user inputs the target pressure by selecting a pressure within a range rather than a particular value. In such an example, the user can first input the desired operating mode and then the input from the pressure selecting input interface will be interpreted differently by the controller 15 to select the target pressure, as discussed in more detail below.

In some examples, the controller 15 is configured such that the tolerance range varies within a pressure range. The tolerance ranges 114a, 114b can be configured as dynamic tolerance ranges. A dynamic tolerance range does not maintain the same pressure differential between the upper and lower thresholds; instead, the pressure differential between the upper and lower thresholds varies depending on the target pressure. The pressure differential increases as the target pressure increases and the pressure differential decreases as the target pressure decreases. In such an example, the value “Y” for tolerance range 114b is smaller for target pressures that are lower within low-pressure range 112 while the value “Y” for tolerance range 114b is greater for target pressures that are higher within low-pressure range 112.

For example, if the user selects the low-pressure mode, then the controller 15 will implement the tolerance range 114b associated with the low-pressure range 112. The user selects a target pressure. With the dynamic tolerance range, the controller 15 will implement a variation of tolerance range 114b depending on the actual target pressure selected by the user. If the user selects a target pressure nearer to the low end of the low-pressure range 112, then the controller 15 implements a tolerance range 114b having a first pressure differential between the lower threshold 116b and the upper threshold 118b. If the user selects a target pressure nearer to the high end of the low-pressure range 112, then the controller 15 implements a tolerance range 114b having a second pressure differential between the lower threshold 116b and the upper threshold 118b, with the second pressure differential being greater than the first pressure differential.

In some examples including dynamic tolerance ranges, the tolerance range 114a at the lowest pressure within the high-pressure range 111 can be larger than the tolerance range 114b at the highest pressure within the low-pressure range 112.

In some examples including dynamic tolerance ranges, the tolerance range 114b for some pressures within the low-pressure range 112 can be larger than the tolerance range 114a for some pressures within the high-pressure range 111. For example, the tolerance range 114b at the high pressure end of the low-pressure range 112 can be larger than the tolerance range 114a at the low pressure end of the high-pressure range 111.

In some examples including dynamic tolerance ranges, the tolerance range 114a is greater than the tolerance range 114b for the same target pressure. For example, the target pressure can be within the overlap range between low-pressure range 112 and high-pressure range 111. With the controller 15 operating in the low-pressure mode the controller 15 controls starting and stopping of the motor 12 based on tolerance range 114b associated with the low-pressure range 112 while with the controller 15 operating in the high-pressure mode the controller 15 controls starting and stopping of the motor 12 based on tolerance range 114a associated with the high-pressure range 111, with tolerance range 114a having a greater span than tolerance range 114b. The user selecting the low pressure mode, such that controller 15 implements tolerance range 114b, provides for more responsive spraying as less pressure change is required to start or stop the motor 12 as compared to the tolerance range 114a. The user selecting the high pressure mode, such that controller 15 implements tolerance range 114a, provides a sprayer that has greater tolerance for pressure variations to prevent starting and stopping of motor 12 while not spraying.

In some examples, the dynamic tolerance range can be proportional based on the selected target pressure within the pressure range. For example, the tolerance range can be based on a percentage of the target pressure. The tolerance range can thus adjust proportionally with changes in the target pressure.

Controller 15 implementing differing tolerance ranges for different pressure ranges provides significant advantages. Tolerance range 114a, which is associated with high-pressure range 111, is larger than tolerance range 114b, which is associated with low-pressure range 112. Implementing a larger tolerance range 114a when spraying in a high-pressure range 111 prevents starting and stopping of the motor 12 due to pressure fluctuations that are experienced due to the nature of the system (e.g., length and width of the hose, etc.). Having a smaller tolerance range 114b when spraying in the low-pressure range 112 provides for a more responsive system that prevents sputtering and spitting when spraying at lower pressures.

The user can select the desired operating mode depending on the configuration of the spray system being utilized for a particular spray job. For example, the user may desire a more responsive system when spraying with a shorter hose that has less pressure variation due to expansion and contraction and in such a case the user can implement the low pressure mode, whereas the user may desire a system more tolerable of pressure variations when spraying with a longer hose that causes greater pressure variation due to expansion and contraction. The mode is selectable by the user. The controller 15 can control operation of motor 12 based on the preprogrammed tolerance ranges depending on the selected operating mode of the controller 15. The controller 15 can operate in a first mode (e.g., one of the high-pressure mode and the low-pressure mode) when the user input selects a first mode setting and the controller 15 can operate in a second mode (e.g., the other one of the high-pressure mode and the low-pressure mode) when the user input selects a second mode setting. The mode setting can be selected by an input via the user interface 17.

In some examples, the user selects the target pressure with an input interface (e.g., user interface 17), such as with a dial, button input, touchscreen, lever, or other input interface. The sprayer can include a single input interface that selects the target pressure. The single input interface provides the target pressure to the controller 15 regardless of the operating mode of the controller 15. The single input interface can be adjustable between a minimum pressure state and a maximum pressure state. The minimum pressure state corresponds with a minimum pressure within a pressure range while the maximum pressure state corresponds with a maximum pressure within the pressure range. The single input interface is adjustable to select the minimum pressure as the target pressure, to select the maximum pressure as the target pressure, or to select pressures intermediate the minimum and maximum pressures as the target pressure.

The single input interface can be incremented between the minimum and maximum pressures to select the target pressure. It is understood that the incrementation can be an adjustment of the target pressure to increase the target pressure or to decrease the target pressure. It is further understood that each increment can be between discrete, fixed positions for the single input interface or can be any change in the single input interface. For example, a dial forming the single input interface can be adjustable between a set number of discrete positions between a minimum pressure setting state and a maximum pressure setting state or can be infinitely adjustable between a minimum pressure setting state and a maximum pressure setting state.

The input from the input interface is remapped based on the selected operating mode of the controller 15. The input is remapped such that the same selection by the input interface is associated with a first target pressure with the controller 15 in the low-pressure mode and with a second target pressure with the controller 15 in the high-pressure mode. For example, the input setting being set at a minimum pressure level will correspond with different pressures depending on if the controller 15 is operating in the low-pressure mode or the high-pressure mode. Similarly, the input setting being set at a maximum pressure level will correspond with different pressures depending on if the controller 15 is operating in the low-pressure mode or the high-pressure mode.

The remapping of the input from the input interface can alter the pressure change per increment of the input interface. In examples in which the pressure differential between the lowest pressure and the highest pressure of the high-pressure range 111 differs from the pressure differential between the lowest pressure and the highest pressure of the low-pressure range 112, a single incrementation of the dial will change the target pressure by a different value depending on whether the controller 15 is operating in the high-pressure mode or the low-pressure mode. For example, if the pressure differential between the lowest pressure of the low-pressure range 112 and the highest pressure of the low-pressure range is less than the pressure differential between the lowest pressure of the high-pressure range 111 and the highest pressure of the high-pressure range 111, then each incrementation of the single input interface will cause a smaller change in the target pressure with the controller 15 in the low-pressure mode than with the controller 15 in the high-pressure mode.

Remapping of the input interface depending on the operating mode of the controller 15 provides significant advantages. The input interface is a single input that selects the target pressure for a spray operation. Having a single input interface provides for a simpler system with less parts. Remapping the input interface allows the low-pressure range 112 and high-pressure range 111 to encompass differently sized pressure ranges while still utilizing a single input interface.

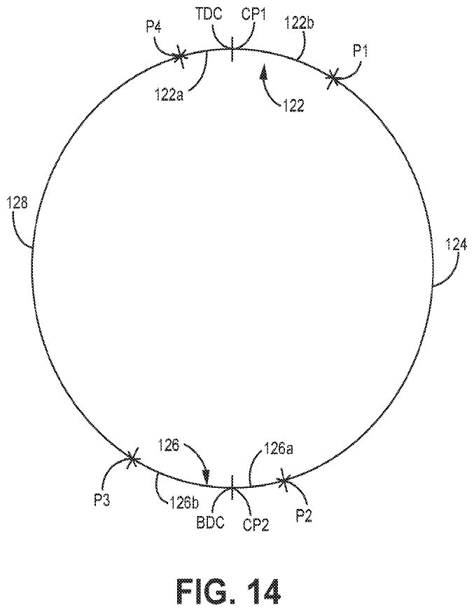

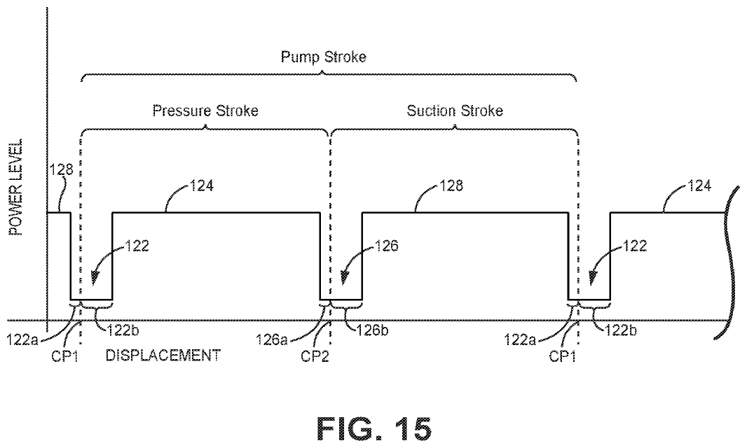

FIG. 14 is a schematic diagram showing application of motor power relative to a rotational position of a drive mechanism 14 that powers pumping by a pump. FIG. 15 is a graph illustrating application of motor power relative to a position of a fluid displacer 16. The drive mechanism 14 is connected to an electric motor 12 and to the fluid displacer 16. The drive mechanism 14, which can be an eccentric drive among other options, receives a rotational output from the motor 12 and converts that rotational output to a reciprocating linear input that is provided to the fluid displacer 16 to power pumping by the pump 19. For example, the drive mechanism 14 can be connected to the fluid displacer 16 to power reciprocation of the fluid displacer 16 relative to a body of the pump 19 to cause pumping by the pump 19.

Motor 12 is an electric motor that includes a stator 20 that is provided with electrical power to cause rotation of a rotor 22 of the electric motor 12. The drive mechanism 14 can be in a direct drive relationship with the fluid displacer 16. The drive mechanism 14 can be directly connected to the fluid displacer 16 such that for each one full rotation of the rotating component of the drive mechanism 14 (e.g., each rotation of the eccentric) the fluid displacer 16 completes one pump cycle, including a suction stroke and a pressure stroke. The drive mechanism 14 is directly connected to the fluid displacer 16 without intermediate gearing such that the fluid displacer 16 completes one pump cycle (including one suction or up stroke and one pressure or down stroke) for each full rotation of the eccentric of the drive mechanism 14.

In some examples, the motor 12 is in a direct drive relationship with the pump 19. In such an example, motor 12 is directly connected to the drive mechanism 14 without intermediate gearing such that a rotating component of the drive mechanism 14 (e.g., an eccentric) rotates in a 1:1 relationship with the rotor 22 of the motor 12. In some examples, a gear reduction is present between the motor 12 and the fluid displacer 16 such that fluid displacer 16 moves through less than one full pump cycle for each rotation of the motor 12. The gear ratio is known such that the position of the fluid displacer 16 can be determined based on the rotational position of the rotor 22.

The electric power supplied to motor 12 can be actively controlled based on the sensed position of the fluid displacer 16. The position of the fluid displacer 16 can be determined based on information generated by a sensor (e.g., sensor 102). The sensor can be configured to directly sense the position of the fluid displacer 16, can be configured to directly sense the position of the rotor 22 from which the position of the fluid displacer 16 can be inferred, can be configured to directly sense the position of the drive mechanism 14 from which the position of the fluid displacer 16 can be inferred, etc. The provision of driving power to the electric motor 12 can be made independent of sensed increases or decreases the fluid pressure or fluid flow which may be fluctuating for a variety of reasons. The provision of driving power can be preprogrammed to controller 15 and not based on any sensed parameter of the fluid. The provision of driving power to the electric motor 12 can be made independent of other sensed parameters of the motor 12, such as changes in the speed of rotor 22, etc. Controlling the provision of driving power based on the sensed position of fluid displacer 16 can assist in eliminating pressure fluctuations, such that the system must anticipate the positions in which the pressure fluctuations occur in order to change power provision to avoid such pressure fluctuations instead of responding to the fluctuations after they begin. The power to the electric motor can be managed by controller 15.

The controller 15 is configured to regulate power to the motor 12 based on the position of the fluid displacer 16. The fluid displacer 16 changes over between strokes at the top dead center (TDC) position and the bottom dead center (BDC) position of the rotating component of the drive mechanism 14. The TDC position is associated with changeover point CP1, where the fluid displacer 16 changes over from the suction stroke to the pressure stroke. The BDC position is associated with changeover point CP2, where the fluid displacer 16 changes over from the pressure stroke to the suction stroke.

The controller 15 provides power to motor 12 based on the position of the fluid displacer 16. In the example shown, the power (e.g., current level, voltage level, etc.) is regulated based on the position of the fluid displacer 16. The power is asymmetrically provided to motor 12 to power pumping by pump 19. The controller 15 is configured to provide reduced power to electric motor 12 as the fluid displacer 16 approaches and exits from the changeover points. The reduced power can be zero power, such that no current is provided to cause rotation of the rotor 22, or can be a reduced, but non-zero, level of power as compared to the driving power level provided to drive the fluid displacer 16 through the respective strokes.

In the example shown, the fluid displacer 16 moves through displacement ranges 122, 124, 126, and 128 during a full pump cycle. The first displacement range 122 is associated with the fluid displacer 16 changing over from the suction stroke to the pressure stroke. The second displacement range 124 is associated with the fluid displacer 16 displacing linearly in a first direction through the pressure stroke. The third displacement range 126 is associated with the fluid displacer changing over from the pressure stroke to the suction stroke. The fourth displacement range 128 is associated with the fluid displacer 16 displacing linearly in a second direction opposite the first direction and through the suction stroke. The first displacement range 122 can be formed by the first end part 104 of a stroke. The third displacement range 126 can be formed as a second end part 108 of a stroke. The second and fourth displacement ranges 124, 128 can be formed as middle portions 106 of a stroke.

The first displacement range 122 begins prior the changeover point CP1 and extends to point P1, which is at the intersection of the first displacement range 122 and the second displacement range 124. The point Pl is during the pressure stroke and after the changeover point CP1. The second displacement range 124 extends from point P1 to point P2, which point P2 is the intersection between the second displacement range 124 and the third displacement range 126. The point P2 is during the pressure stroke and prior to the changeover point CP2. The third displacement range 126 begins prior to the changeover point CP2 and extends to point P3, which is at the intersection of the third displacement range 126 and the fourth displacement range 128. The point P3 is during the suction stroke and after the changeover point CP2. The fourth displacement range 128 extends from point P3 to point P4, which point P4 is the intersection between the fourth displacement range 128 and the first displacement range 122. The point P4 is during the suction stroke and prior to the changeover point CP1.

The first displacement range 122 includes first sub-range 122a and second sub-range 122b. The first sub-range 122a is associated with the fluid displacer 16 moving through an end of the suction stroke and reaching the changeover point CP1 at the TDC position of the rotating component of the drive mechanism 14. The second sub-range 122b is associated with the fluid displacer 16 passing the changeover point CP1 and having reversed linear displacement direction to begin to move through the pressure stroke. The fluid displacer 16 changes over from the suction stroke to the pressure stroke while moving through the first displacement range 122.

In some examples, the first sub-range 122a is smaller than the second sub-range 122b such that the fluid displacer 16 moves for a shorter distance from point P4 to the changeover point CP1 than from the changeover point CP1 to the point P1. The point P4 at the beginning of the first sub-range 122a can be associated with the fluid displacer 16 being a certain distance from the changeover point CP1, can be associated with the eccentric being at a certain rotational position relative to TDC, etc. The point P1 at the end of the second sub-range 122b can be associated with the fluid displacer 16 being a certain distance beyond the changeover point CP1, can be associated with the eccentric being at a certain rotational position relative to TDC, etc.

In some examples, the second sub-range 122b is at least twice as large as the first sub-range 122a. In some examples, the second sub-range 122b is at least three times as large as the first sub-range 122a. It is understood that the second sub-range 122b can be the same size as or at least two, three, four, or more times as large as the first sub-range 122a. In some examples, the first sub-range 122a begins with the drive being about ten rotational degrees away from the TDC position. In some examples, the second sub-range 122b extends to the drive being up to about thirty rotational degrees away from the TDC position.

The second displacement range 124 extends between the first displacement range 122 and the third displacement range 126. The second displacement range 124 extends from point P1 to point P2. The fluid displacer 16 moves in a single linear direction through the second displacement range 124. The fluid displacer 16 does not changeover between stroke directions while moving through the second displacement range 124.

The third displacement range 126 includes first sub-range 126a and second sub-range 126b. The first sub-range 126a is associated with the fluid displacer 16 moving through an end of the pressure stroke and reaching the changeover point CP2 at the BDC position of the rotating component of the drive mechanism 14. The second sub-range 126b is associated with the fluid displacer 16 passing the changeover point CP2 and having reversed linear displacement direction to begin moving through the suction stroke. The fluid displacer 16 changes over from the pressure stroke to the suction stroke while moving through the third displacement range 126.

In some examples, the first sub-range 126a is smaller than the second sub-range 126b such that the fluid displacer 16 moves for a shorter distance from point P2 to the changeover point CP2 than from the changeover point CP2 to the point P3. The point P2 at the beginning of the first sub-range 126a can be associated with the fluid displacer 16 being a certain distance from the changeover point CP2, can be associated with the eccentric being at a certain rotational position relative to BDC, etc. The point P3 at the end of the second sub-range 126b can be associated with the fluid displacer 16 being a certain distance beyond the changeover point CP2, can be associated with the eccentric being at a certain rotational position relative to BDC, etc.

In some examples, the second sub-range 126b is at least twice as large as the first sub-range 126a. In some examples, the second sub-range 126b is at least three times as large as the first sub-range 126a. It is understood that the second sub-range 126b can be the same size as or at least two, three, four, or more times as large as the first sub-range 126a. In some examples, the first sub-range 126a begins with the drive being about ten rotational degrees away from the BDC position. In some examples, the second sub-range 126b extends to the drive being up to about thirty rotational degrees away from the BDC position.

The fourth displacement range 128 extends between the third displacement range 126 and the first displacement range 122. The fourth displacement range 128 extends from point P3 to point P4. The fluid displacer 16 moves in a single linear direction through the fourth displacement range 128. The fluid displacer 16 does not changeover between stroke directions while moving through the fourth displacement range 128. The fluid displacer 16 move in an opposite direction through the fourth displacement range 128 as compared to the second displacement range 124.

The controller 15 is configured to regulate power to the motor 12 based on the sensed position of the fluid displacer 16. The controller 15 is configured to provide a relatively greater power level to the motor 12 with the fluid displacer 16 moving linearly through the second displacement range 124 and the fourth displacement range 128 and the controller 15 is configured to provide a relatively lower power level to the motor 12 with the fluid displacer approaching, moving through, and exiting from the changeover in the first displacement range 122 and the third displacement range 126. The power provision discussed is provided by the controller 15 during spraying by the fluid spraying system, in which the pump 19 is being actively driven to output fluid for spraying by the spray gun.

By way of example, power provision for motor 12 is discussed for a pump cycle, beginning at point P4 at the beginning of the first displacement range 122. The controller 15 provides a first power level to the motor 12 as the fluid displacer 16 moves through positions within the first displacement range 122. The first power level is less than the fourth power level provided to drive the fluid displacer 16 through the fourth displacement range 128. In some examples, controller 15 can reduce the power level such that the motor 15 is allowed to coast as the fluid displacer 16 moves through the first displacement range 122. In some examples, the controller 15 can continue to provide power to motor 12 as the motor 12 coasts, such that the first power level is greater than zero but still less than the fourth power level. For example, controller 15 can throttle back the power level with fluid displacer 16 in the first displacement range 122 relative to the power level provided with the fluid displacer 16 in the fourth displacement range 128. In some examples, controller 15 can shut off power to the motor 12 as the motor 12 coasts, such that the first power level is zero power.

In some examples, controller 15 is configured to reduce the power level provided to the motor 12 with the fluid displacer 16 in the first displacement range 122 such that the rotor 22 is still urged to rotate by the power provided to the stator 20 but that power level is less than the power level provided in the fourth displacement range 128.

The motor 12 is thus provided with reduced power before changeover of the fluid displacer 16 (at positions within sub-range 122a), at changeover of the fluid displacer 16 (at the CP1 position), and after changeover of the fluid displacer 16 (at positions within sub-range 122b). It is understood that the first power level can be the same as the third power level provided to the motor 12 as the fluid displacer 16 moves through the third displacement range 126.

The fluid displacer 16 is driven through the first displacement range 122 and the power to the motor 12 is increased to a second power level when fluid displacer 16 reaches point P1, at the end of the first displacement range 122 and the beginning of the second displacement range 124. The power level to the motor 12 is increased to the second power level and the fluid displacer 16 is driven through the second displacement range 124. The controller 15 provides the second power level to the motor 12 as the fluid displacer 16 moves through the second displacement range 124 to drive the fluid displacer 16 through the pressure stroke. The fluid displacer 16 displaces until reaching point P2 at the beginning of the third displacement range 126.

The controller 15 provides a third power level to the motor 12 as the fluid displacer 16 moves through the third displacement range 126. The third power level is less than the second power level provided to drive the fluid displacer 16 through the second displacement range 124. The controller 15 reduces the power provided to the motor 12 based on the sensed position of the fluid displacer 16 reaching the point P2 during the pressure stroke. In some examples, controller 15 can reduce the power level such that the motor 15 is allowed to coast as the fluid displacer 16 moves through the third displacement range 126. In some examples, controller 15 can continue to provide power to motor 12 as the motor 12 coasts, such that the third power level is greater than zero but still less than the second power level. For example, controller 15 can throttle back the power level with fluid displacer 16 in the third displacement range 126 relative to the power level provided with the fluid displacer 16 in the second displacement range 124. In some examples, controller 15 can shut off power to the motor 12 as the motor 12 coasts, such that the third power level is zero power.

In some examples, the controller 15 is configured to reduce the power level provided to the motor 12 with the fluid displacer 16 in the third displacement range 126 such that the rotor 22 is still urged to rotate by the power provided to the stator 20 but that power level is less than the power level provided in the second displacement range 124.

The motor 12 is thus provided with reduced power before changeover of the fluid displacer 16 (at positions within sub-range 126a), at changeover of the fluid displacer 16 (at the CP2 position), and after changeover of the fluid displacer 16 (at positions within sub-range 126b).

The third power level is provided to the motor 12 as fluid displacer 16 moves through the third displacement range 126 from point P2 to the end of the pressure stroke at the CP2 position and from the CP2 position to point P3. Point P3 is at the end of the third displacement range 126 and the beginning of the fourth displacement range 128.

The controller 15 increases the power provided to motor 12 to a fourth power level based on the sensed position of the fluid displacer 16 indicating that the fluid displacer 16 has reached the point P3 during the suction stroke. The controller 15 provides the fourth power level to the motor 12 with the fluid displacer 16 in the fourth displacement range 128 to drive the fluid displacer 16 through the suction stroke. The fourth power level is greater than the third power level. The fourth power level can be the same as the second power level. The second and fourth power levels can be referred to as driving power levels as the motor is actively driving the fluid displacer 16 through a linear stroke within such displacement ranges.

The fourth power level is provided to motor 12 to displace the fluid displacer 16 through the fourth displacement range 128 and until the fluid displacer 16 reaches point P4. Point P4 is associated with a position of the fluid displacer 16 at the end of the fourth displacement range 128 and the beginning of the first displacement range 122. The power level to the motor 12 is decreased to the first power level based on the sensed position of the fluid displacer 16 reaching point P4 and the fluid displacer 16 is driven through the first displacement range 122. The controller 15 continues to direct power to the motor 12 based on the sensed position of the fluid displacer 16 to drive the fluid displacer 16 through pump strokes. The pump stroke can be either of the suction stroke and the pressure stroke.

While the power level provided to the motor 12 is reduced as the fluid displacer 16 moves through changeover (i.e., in the first displacement range 122 and the third displacement range 126) the fluid displacer 16 can still be caused to accelerate while moving within those displacement ranges 122, 126. For example, when the fluid displacer 16 changes over between strokes, the pressure in one of the upstream and downstream chambers 88a, 88b can be less than the pressure in the other chamber due to delay in valves 95, 96 closing and such pressure differential can assist in displacing the fluid displacer 16. For example, when the fluid displacer 16 changes over from the suction stroke to the pressure stroke, the pressure in the upstream chamber 88a can be less than the pressure in the downstream chamber 88b, such as before the inlet check valve 96 seats. That pressure differential can assist in pulling the fluid displacer 16 into the suction stroke and can accelerate the fluid displacer 16 even through the power provided to motor 12 is reduced. Further, the mechanical advantage provided by the drive mechanism 14 and momentum of the drive mechanism 14 assists in continuing to drive the fluid displacer 16 in displacement ranges 122, 126 even while the power to the motor 12 is reduced.

In the example shown, the fluid displacer 16 moves through sub-range 122b, second displacement range 124, and sub-range 126a from the beginning to an end of a pressure stroke. The sub-range 122b forms an upper portion of the pressure stroke, the second displacement range 124 forms a middle portion of the pressure stroke, and the sub-range 126a forms a lower portion of the pressure stroke. The sub-range 122b forms a beginning of the pressure stroke, the second displacement range 124 provides a middle portion of the pressure stroke, and the sub-range 126a forms an end of the pressure stroke.

The power level provided to the motor 12 is at a relatively lower level for the beginning and the end portions of the pressure stroke and the power level is at a relatively higher level in the middle portion of the pressure stroke. The power level is at the relatively lower level from the changeover point CP1, with the drive mechanism at the TDC position, to point P1 between the first displacement range 122 and the second displacement range 124. The power level is at the relatively higher level throughout the second displacement range 124. The power level is again reduced as the fluid displacer 16 moves through the sub-range 126b from point P2 between the second displacement range 124 and the third displacement range 126 and approaches the changeover point CP2, at which point the drive mechanism is at the BDC position. The power level provided to the motor 12 is greater with the fluid displacer 16 in mid-stroke (in second displacement region 124) than at the ends of the stroke, in sub-regions 122b and 126a. While the power level is reduced at the ends of the stroke the fluid displacer 16 is accelerating at the ends of the stroke.

In the example shown, the controller 15 provides the relatively greater power level to the motor 12 over a larger portion of the pressure stroke than the controller 15 provides the relatively lower power level to the motor 12. In some examples, the second displacement range 124 extends up to about 75% of the total displacement through the pressure stroke. In some examples, the second displacement range 124 extends up to about 70% of the total displacement through the pressure stroke. In some examples, the second displacement range 124 extends up to about 60% of the total displacement through the pressure stroke. The second displacement range 124 extends more than 50% of the total displacement through the pressure stroke. In the example shown, the middle portion of the pressure stroke, formed by second displacement range 124, forms a majority of the overall displacement distance for fluid displacer 16 from the changeover point CP1 to the changeover point CP2.

In some examples, the sub-region 122b forms up to about 13.5% of the total displacement through the pressure stroke. In some examples, the sub-region 122b forms up to about 16.67% of the total displacement through the pressure stroke. In some examples, the sub-region 122b forms up to about 20% of the total displacement through the pressure stroke.

In some examples, the sub-region 126a forms up to about 4% of the total displacement through the pressure stroke. In some examples, the sub-region 126a forms up to about 5% of the total displacement through the pressure stroke. In some examples, the sub-region 126a forms up to about 6% of the total displacement through the pressure stroke.

In the example shown, the fluid displacer 16 moves through sub-range 126b, fourth displacement range 128, and sub-range 122a from the beginning to an end of a suction stroke. The sub-range 126b forms a lower portion of the suction stroke, the fourth displacement range 128 forms a middle portion of the suction stroke, and the sub-range 122a forms an upper portion of the suction stroke. The sub-range 126b forms a beginning of the suction stroke, the fourth displacement range 128 provides a middle portion of the suction stroke, and the sub-range 122a forms an end of the suction stroke.

The power level provided to the motor 12 is at a relatively lower level for the beginning and the end portions of the suction stroke and the power level is at a relatively higher level in the middle portion of the suction stroke. The power level is at the relatively lower level from the changeover point CP2, with the drive mechanism at the BDC position, to point P3 between the third displacement range 126 and the fourth displacement range 128. The power level is at the relatively higher level throughout the fourth displacement range 128. The power level is again reduced as the fluid displacer 16 moves through the sub-range 122b from point P4 between the fourth displacement range 128 and the first displacement range 122 and approaches the changeover point CP1, at which point the drive mechanism is at the TDC position. The power level provided to the motor 12 is greater with the fluid displacer 16 in mid-stroke (in the fourth displacement region 128) than at the ends of the stroke, in sub-regions 126b and 122a. While the power level is reduced at the ends of the stroke the fluid displacer 16 is accelerating at the ends of the stroke.

In the example shown, the controller 15 provides the relatively greater power level to the motor 12 over a larger portion of the suction stroke than the controller 15 provides the relatively lower power level to the motor 12. In some examples, the fourth displacement range 128 extends up to about 75% of the total displacement through the suction stroke. In some examples, the fourth displacement range 128 extends up to about 70% of the total displacement through the suction stroke. In some examples, the fourth displacement range 128 extends up to about 60% of the total displacement through the suction stroke. The fourth displacement range 128 extends more than 50% of the total displacement through the suction stroke. In the example shown, the middle portion of the suction stroke, formed by fourth displacement range 128, forms a majority of the overall displacement distance for fluid displacer 16 from the changeover point CP2 to the changeover point CP1.

In some examples, the sub-region 126b forms up to about 13.5% of the total displacement through the suction stroke. In some examples, the sub-region 126b forms up to about 16.67% of the total displacement through the suction stroke. In some examples, the sub-region 126b forms up to about 20% of the total displacement through the suction stroke.

In some examples, the sub-region 122a forms up to about 4% of the total displacement through the suction stroke. In some examples, the sub-region 122a forms up to about 5% of the total displacement through the suction stroke. In some examples, the sub-region 122a forms up to about 6% of the total displacement through the suction stroke.

The controller 15 reducing power as the fluid displacer 16 approaches the changeover point, as the fluid displacer 16 changes over, and as the fluid displacer 16 moves away from the changeover point provides significant advantages. Reducing power through the first displacement range 122 and the third displacement range 126 reduces the total power draw to the motor 12, which provides for a greater range between the actual current level provided to motor 12 and the maximum current level allowable for motor 12 when the fluid displacer 16 reaches points P1/P3, which are the displacement locations at which additional power is required to actively drive the motor 12 to drive displacement of the fluid displacer 16. The mechanical advantage provided by the drive mechanism 14 in first displacement range 122 and second displacement range 126 drives fluid displacer 16 without requiring additional driving input from the motor 12. Further, the pressure differentials in the pumping chambers during changeover also assists in driving the fluid displacer 16. As such, the fluid displacer 16 accelerates through changeover without requiring additional driving power to the motor 12. The motor 12 can be provided with reduced power while fluid displacer 16 moves through the first displacement range 122 and third displacement range 126. In some examples, controller 15 provides reduced power such that the rotor 22 is not actively driven forward but instead coasts. The reduced power to allow coasting of the rotor 22 can be greater than zero power such that the power level is throttled back relative to driving power or can be zero power. As such, less power is required by the fluid sprayer, providing a power savings, and providing for more available current between the actual level provided to motor 12 and a maximum current level for motor 12 when the fluid displacer 16 enters into the second displacement range 124 and the fourth displacement range 128. Having the additional driving power available prevents stalling, which can briefly occur at point P1 or P3 due to a deficit in available power drive motor 12.

The power to motor 12 is proactively controlled based on the sensed position of the fluid displacer 16. In other systems, the power to motor 12 may be reduced, but such reduction is reactive to changes in the system (e.g., sensing an increase in motor speed and then reducing power, sensing a decrease in motor speed and then increasing power, etc.). Proactively, rather than reactively, controlling the power provided to motor 12 provides a more responsive system that outputs steady fluid flow and pressure, providing for consistent spraying by the spray gun.

While controller 15 is described above as controlling operation of motor 12 based on the fluid displacer 16 moving through changeover, it is understood that not all examples are so limited. In some examples, controller 15 is configured to control the power level of the electric power provided to motor 12 based on the position of the fluid displacer 16 within a stroke, which position can be determined directly based on sensing a linear position of the fluid displacer 16 or indirectly based on sensing a rotational position of the rotor 22 of the electric motor 12. In such an example, the controller 15 is configured to vary the power level to the electric motor 12 based on sensed position, not based on a fluid parameter downstream of pump 19, such as pressure or flow. Such power control based on position is pre-programmed and purposeful based on the position, not reactive to fluctuations in pressure, current, flow, etc.

The controller 15 is configured to vary the power level to the electric motor 12 based on the fluid displacer 16 moving through certain pre-set portions of a pump stroke. As discussed above, the pre-set portions of the pump stroke can be associated with changeover, but not all examples are so limited. Controller 15 receives information regarding the position of the fluid displacer 16 within a pump stroke from a sensor 102 and varies the power level provided to the motor 12 depending on the sensed position of the fluid displacer 16. The sensor 102, whether directly sensing a position of fluid displacer 16 or sensing a position of rotor 22, provides information regarding the location of the fluid displacer 16 within the pump stroke. The controller 15 varies the power level to the motor 12 based on the sensed position, such that a relatively lower power level is provided to motor 12 with fluid displacer 16 in certain positions within the pump stroke and a relatively greater power level is provided to motor 12 with fluid displacer 16 in other positions within the pump stroke.

Controller 15 is configured to actively vary the power level to the motor 12 based on the sensed position of the fluid displacer 16. The power variation is not based on pressure or flow data regarding the fluid output by pump 19. Instead, the power variation is based on position. Such a configuration provides efficient pumping as controller 15 actively controls power based on known position of the fluid displacer 16, rather than responsively based on pressure or flow fluctuations.

It is understood that controller 15 can cause motor 12 to start and stop pumping based on pressure, as discussed with regard to FIGS. 11-13, but that controller 15 does not rely on pressure information to vary the power levels provided to the motor 12 during pumping.

Controller 15 controlling the power levels provided to motor 12 during pumping based on the known position of the fluid displacer 16 provides significant advantages. The controller 15 varies the power levels based on the known position of fluid displacer 16, providing for active control of the power levels that is based on the actual position of the fluid displacer 16, rather than that is responsive to some parameter variation in the pumped fluid. Such a configuration provides for quick control and efficient operation of motor 12 and pump 19. Such power control based on position of the fluid displacer 16 provides for more efficient pumping relative to the actual operation of the spray system 1. For example, the fluid displacer 16 may take longer or shorter amount of time to complete a stroke. The controller 15 controlling power provision based on the actual position of fluid displacer 16 ensures that any power variation is completed in the desired portion of the pump stroke.

While the invention(s) has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention(s) without departing from the essential scope thereof. Therefore, it is intended that the invention(s) not be limited to the particular embodiment(s) disclosed, but that the invention(s) may include all embodiments falling within the scope of the appended claims. Any single feature, or any combination of features from one embodiment show herein, may be utilized in a different embodiment independent from the other features shown in the embodiment herein. Accordingly, the scope of the invention(s) and any claims thereto are not limited to the particular to the embodiments and/or combinations of the features shown herein, but rather can include any combination of one, two, or more features shown herein.

1. A fluid sprayer comprising:
an electric motor that outputs rotational motion;
a drive that converts the rotational motion output from the electric motor into linear reciprocating motion;
a pump driven by the drive;
a hose that receives an output of a fluid from the pump;
a spray gun that receives the fluid from the hose;
at least one sensor; and
a controller configured to receive an output from the at least one sensor and control operation of the electric motor based on the output from the at least one sensor.

2. The fluid sprayer of claim 1, wherein the controller is configured to operate in either a first mode or a second mode based on a user input, wherein:
in the first mode the controller is configured to cease output from the pump by stopping rotation of the electric motor when a fluid parameter that is monitored by the sensor crosses a first threshold, and resume output from the pump by restarting rotation of the electric motor when the fluid parameter that is monitored by the sensor crosses a second threshold, the first threshold different than the second threshold;
in the second mode the controller is configured to cease output from the pump by stopping rotation of the electric motor when the fluid parameter that is monitored by the sensor crosses a third threshold, and resume output from the pump by restarting rotation of the electric motor when the fluid parameter that is monitored by the sensor crosses a fourth threshold, the third threshold different than the fourth threshold; and
a first difference between the first threshold and the second threshold is less than a second difference between the third threshold and the fourth threshold.

3. The fluid sprayer of claim 2, wherein the fluid parameter is pressure and each of the first threshold, the second threshold, the third threshold, and the fourth threshold respectively represent different pressure values.

4. The fluid sprayer of claim 2, wherein the first threshold is greater than the second threshold, and the third threshold is greater than the fourth threshold, and each of the third threshold and the fourth threshold are greater than each of the first threshold and the second threshold.

5. The fluid sprayer of claim 2, wherein the controller is configured to operate in the first mode when the user input selects a first pressure setting in a first pressure range and operate in the second mode when the user input selects a second pressure setting in a second pressure range, the second pressure range representing higher pressure than the first pressure range.

6. (canceled)

7. (canceled)

8. The fluid sprayer of claim 2, wherein:
the first mode is associated with a first pressure range extending between a first lower pressure value and a first upper pressure value;
the second mode is associated with a second pressure range extending between a second lower pressure value and a second upper pressure value; and
the first upper pressure value is intermediate the second lower pressure value and the second upper pressure value.

9. The fluid sprayer of claim 1, wherein the pump comprises:
a pump chamber;
a fluid displacer that reciprocates along a reciprocation path within the pump chamber to alternately increase and decrease space within the pump chamber for the fluid;
a first check valve upstream of the pump chamber, the first check valve configured to prevent retrograde flow of the fluid; and
a second check valve configured to prevent retrograde flow of the fluid.

10. The fluid sprayer of claim 9, wherein the controller is configured to control the speed of the electric motor such that the electric motor is spinning faster during changeover when the fluid displacement member is reversing direction than when the fluid displacement member is in the middle of a pump stroke.

11. The fluid sprayer of claim 9, wherein the controller is configured to control the speed of the electric motor such that the electric motor is spinning faster coming out of changeover just after the fluid displacement member reversed direction and then the electric motor slows down for a middle portion of stroking, the middle portion comprising at least half of the reciprocation path of each stroke.

12. The fluid sprayer of claim 9, wherein:
the reciprocation path for each stroke of a plurality of strokes comprises a first end portion, a middle portion, and a second end portion;
for each stroke of the plurality of strokes, the fluid displacement member is first moved through the first end portion, then the middle portion, and then the second end portion; and
the controller is configured to control the speed of the electric motor such that the electric motor is spinning faster in the first end portion than in the middle portion such that the fluid displacement member moves faster in at least a portion of the first end portion than in the middle portion.

13. The fluid sprayer of claim 12, wherein the controller is configured to control the speed of the electric motor such that the electric motor is spinning faster in the second end portion than in the middle portion such that the fluid displacement member moves faster in at least a portion of the second end portion than in the middle portion.

14-17. (canceled)

18. The fluid sprayer of claim 9, wherein the controller is configured to control the speed of the electric motor such that the electric motor accelerates to spin faster as the fluid displacement member approaches a changeover and decelerates to spin slower after the fluid displacement member completes the changeover.

19. (canceled)

20. (canceled)

21. The fluid sprayer of claim 2, further comprising:
a user interface configured to receive a parameter output setting from a user, the controller configured to control operation of the electric motor based on the parameter output setting;
wherein the first threshold is based on the parameter output setting; and
wherein the third threshold is based on the parameter output setting.

22. The fluid sprayer of claim 21, wherein the parameter output setting is set within a range between a minimum output setting and a maximum output setting.

23. (canceled)

24. (canceled)

25. The fluid sprayer of claim 1, the controller is configured to operate in either a first mode or a second mode based on a user input along a parameter range, wherein:
in the first mode the controller is configured to cease output from the pump by stopping rotation of the electric motor when a fluid parameter that is monitored by the sensor crosses a first threshold, and resume output from the pump by restarting rotation of the electric motor when the fluid parameter that is monitored by the sensor crosses a second threshold, the first threshold different than the second threshold;
in the second mode the controller is configured to cease output from the pump by stopping rotation of the electric motor when the fluid parameter that is monitored by the sensor crosses a third threshold, and resume output from the pump by restarting rotation of the electric motor when the fluid parameter that is monitored by the sensor crosses a fourth threshold, the third threshold different than the fourth threshold;
one of the first threshold and the second threshold is set based on the user input;
an other one of the first threshold and the second threshold is set based on the one of the first threshold and the second threshold;
one of the third threshold and the fourth threshold is set based on the user input;
an other one of the third threshold and the fourth threshold is set based on the one of the third threshold and the fourth threshold.

26. The fluid sprayer of claim 25, wherein the parameter range is a pressure range.

27. The fluid sprayer of claim 25, wherein a first difference between the first threshold and the second threshold is less than a second difference between the third threshold and the fourth threshold.

28. The fluid sprayer of claim 25 wherein the first threshold and the third threshold are set based on the user input, the second threshold is set based on a first variation from the first threshold, the fourth threshold is set based on a second variation from the third threshold, and the first variation is less than the second variation.

29-52. (canceled)

53. A fluid sprayer comprising:
an electric motor that outputs rotational motion;
a drive that converts the rotational motion output from the electric motor into linear reciprocating motion;
a pump driven by the drive;
a hose that receives an output of a fluid from the pump;
a spray gun that receives the fluid from the hose;
at least one sensor configured to generate information regarding a pressure output by the pump;
an input interface configured to provide pressure setting information regarding a target pressure to the controller; and
a controller configured to:
set the target pressure based on the pressure setting information;
control operation of the electric motor based on the information from the at least one sensor and based on the target pressure; and
remap the input interface based on an operating mode of the controller such that each increment of the input interface adjusts the target pressure by a first pressure value with the controller in a first mode and the each increment adjusts the target pressure by a second pressure value with the controller in a second mode, the first pressure value differing from the second pressure value.

54-60. (canceled)

61. A fluid sprayer comprising:
an electric motor configured to output rotational motion;
a drive configured to convert the rotational motion output by the electric motor into linear reciprocating motion;
a pump including a fluid displacer that is connected to the drive to be driven by the drive;
a hose that receives an output of a fluid from the pump;
a spray gun that receives the fluid from the hose;
at least one sensor configured to generate information regarding a sensed position of the fluid displacer; and
a controller configured to receive the information from the at least one sensor and control operation of the electric motor based on the sensed position of the fluid displacer.

62-112. (canceled)
